(19) United States
(12) Patent Application Publication
(10) Pub. No.: US 2009/0115335 A1
(43) Pub. Date: May 7, 2009

(54) PLASMA DISPLAY PANEL AND METHOD OF PRODUCING THE SAME

(75) Inventors: Shinya Hasegawa, Osaka (JP); Osamu Inoue, Osaka (JP); Akira Kawase, Osaka (JP); Yasuhiko Nakada, Osaka (JP); Kazuhiro Yokota, Hyogo (JP); Tsutomu Koshizuka, Osaka (JP); Seiji Toyoda, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Kadoma-shi, Osaka (JP)

(21) Appl. No.: 12/304,829

(22) PCT Filed: Jun. 15, 2007
(86) PCT No.: PCT/JP2007/062146

§ 371 Date: Dec. 15, 2008

(30) Foreign Application Priority Data
Jun. 28, 2006 (JP) 2006-177857
Oct. 3, 2006 (JP) 2006-272247

(51) Int. Cl. H01J 17/49; H01J 9/24

(52) U.S. Cl. 313/586; 445/24

(57) ABSTRACT

A plasma display panel of the present invention includes a display electrode (5) and an address electrode (10) that cross each other. At least one selected from the display electrode (5) and the address electrode (10) is covered with a first dielectric layer (6) containing first glass. The first glass contains Bi₂O₃, and the electrode that is covered with the first dielectric layer (6) contains at least one selected from the group consisting of silver and copper. The first glass further contains 0 to 4 wt % of MoO₃ and 0 to 4 wt % of WO₃, and the total of the contents of MoO₃ and WO₃ in the first glass is in a range of 0.1 to 8 wt %.

### TECHNICAL FIELD

The present invention relates to a plasma display panel and a method of producing the same.

### BACKGROUND ART

In recent years, flat panel displays, such as plasma display panels (hereinafter also referred to as “PDPs”), FEDs, and liquid crystal displays, have been gaining attention as displays that can achieve reductions in thickness and weight.

These flat panel displays each are provided with a front panel and a back panel, each of which includes a glass substrate and components disposed thereon. The front panel and the back panel are arranged to oppose each other, and the peripheries thereof are sealed.

As described above, a PDP has a configuration in which the front panel and the back panel are arranged to oppose each other and the peripheries thereof are sealed with sealing glass. The front panel includes: a front glass substrate; stripe-like display electrodes that are formed on the surface of the front glass substrate; and a dielectric layer and a protective layer that further are formed on the display electrodes. The back panel includes: a back glass substrate; stripe-like address electrodes that are formed on the surface of the back glass substrate; a dielectric layer that is formed on the address electrodes; barrier ribs that are formed between adjacent address electrodes; and phosphor layers, each of which is formed between the adjacent barrier ribs.

The front panel and the back panel are arranged so as to oppose each other and to allow the display electrodes and the address electrodes to be orthogonal to each other. In this state, their peripheries are sealed. The sealed spaces formed inside are filled with a discharge gas.

Two display electrodes compose a pair of electrodes. The region defined by such a pair of display electrodes and one address electrode that cross each other three-dimensionally, with a discharge space being interposed therebetween, serves as a cell that contributes to an image display.

Hereafter, the dielectric layer of the PDP is described in detail. The dielectric layer of the PDP is required to have, for example, the following properties: higher insulation to allow it to be formed on electrodes; a lower relative dielectric constant to achieve lower power consumption; and a thermal expansion coefficient that matches with that of the glass substrate so that neither peeling nor cracks occur. Furthermore, in order to use the light emitted from phosphors as display light efficiently, the dielectric layer to be formed on the front glass substrate usually is required to be amorphous glass having a high visible light transmittance.

The dielectric layer is formed by applying a glass paste onto a glass substrate by, for example, screen printing and then drying and baking it. The glass paste usually contains glass powder, resin, and a solvent, and also may contain an inorganic filler and an inorganic pigment in some cases. On the other hand, from the viewpoints of the price, availability, etc., soda lime glass produced by a float process generally is used as a glass substrate to be used for a PDP. Accordingly, the glass paste is baked at a temperature of 600° C. or lower, at which the glass substrate is not deformed.

Since the dielectric layer that is used for the PDP has to be baked at a temperature that causes no deformation of the glass substrate, it is necessary to form it with glass having a relatively low melting point. Hence, PbO—SiO₂-based glass whose main raw material is PbO is used mainly at present.

Such a dielectric layer of the PDP is formed by baking a glass paste containing resin and a solvent. Accordingly, the dielectric layer may be colored by carbon-containing impurities that remain therein, which may cause a deterioration in luminance. For the purpose of suppressing such a deterioration in luminance, glass for covering transparent electrodes has been proposed that is obtained by adding MoO₃ or Sb₂O₃ to glass containing PbO (for instance, see JP2001-151532A).

Furthermore, in consideration of environmental problems, dielectric layers that are free from lead have been developed. For example, a dielectric layer produced using Bi₂O₃—B₂O₃—ZnO—R₂O-based glass (R: Li, Na, K) has been proposed (for instance, see JP2001-139345A). Moreover, when glass containing an alkali metal oxide is used, in order to reduce the pinholes that are produced by baking the glass on aluminum electrodes, glass that contains CuO, CoO, MoO₃, or NiO added thereto has been proposed (for instance, see JP2002-362941A).

As described above, the dielectric layers produced using lead-free glass have been proposed conventionally. In such cases, however, the dielectric layer or the front glass substrate may turn yellow because the glass contains a bismuth oxide that is used instead of lead to obtain a lower softening point. Conceivably, the mechanism that causes this yellowing is as follows.

Ag or Cu is used for the display electrodes to be provided on the front glass substrate and the address electrodes to be provided on the back glass substrate. The Ag or Cu may ionize and then may leak into and diffuse in the dielectric layer and the glass substrate during the baking that is carried out in forming the dielectric layer. The diffused Ag ions or Cu ions tend to be reduced by alkali metal ions or bismuth oxides that are contained in the dielectric layer or Sn ions (bivalent) contained in the front glass substrate. In that case, the Ag ions or Cu ions become colloidal. When the Ag or Cu ions have become colloidal as described above, the dielectric layer and front glass substrate are colored yellow or brown, i.e. so-called yellowing occurs (for instance, J. E. SHELBY and J. VITKO Jr., Journal of Non-Crystalline Solids, vol. 50 (1982) 107-117). Since such yellowed glass absorbs light with a wavelength of 400 nm, a PDP produced using the glass has inferior blue luminance or inferior chromaticity. Hence, yellowing is a problem, especially in the front panel. Furthermore, since Ag colloids and Cu colloids have conductivity, they lower the withstand voltage of the dielectric layer. In addition, since Ag and Cu colloids deposit as colloidal particles that are far larger than ions, they reflect the light that passes through the dielectric layer and thereby cause the deterioration in luminance of the PDP.

### DISCLOSURE OF INVENTION

In view of the above problems, it is an object of the present invention to provide a highly reliable plasma display panel that is provided with a dielectric layer having a high withstand voltage and that prevents not only the dielectric layer and the glass substrate from yellowing but also dielectric breakdown from occurring. It is also an object of the present invention to provide a method of producing the same.

In order to achieve the above objects, a plasma display panel according to the present invention includes a display electrode and an address electrode that cross each other. At least one selected from the display electrode and the address electrode is covered with a first dielectric layer containing first glass. In this plasma display panel, the first glass contains Bi₂O₃, and the electrode that is covered with the first dielectric layer contains at least one selected from the group consisting of silver and copper. The first glass further contains 0 to 4 wt % of MoO₃ and 0 to 4 wt % of WO₃, and the total of the contents of MoO₃ and WO₃ in the first glass is in a range of 0.1 to 8 wt %.

In the plasma display panel according to the present invention, the content of Bi₂O₃ in the first glass can be 2 to 40 wt %.

In the plasma display panel according to the present invention, it is preferable that the first glass contains, as components thereof.

### 0 to 15 wt % SiO₂;

### 10 to 50 wt % B₂O₃;

### 15 to 50 wt % ZnO;

### 0 to 10 wt % Al₂O₃;

### 2 to 40 wt % Bi₂O₃;

### 0 to 5 wt % MgO;

### 5 to 38 wt % CaO+SrO+BaO;

### 0 to 4 wt % MoO₃; and

### 0 to 4 wt % WO₃, and

that the total of the contents of MoO₃ and WO₃ in the first glass is in a range of 0.1 to 8 wt %. In this case, the first glass further may contain, as components thereof, at least one selected from the group consisting of Li₂O, Na₂O, and K₂O, in addition to the above-mentioned components. The total of the contents of Li₂O, Na₂O, and K₂O in the first glass can be in a range of 0.1 to 10 wt %, for example.

In the plasma display panel according to the present invention, it is more preferable that the first glass contains, as components thereof.

### 0 to 15 wt % SiO₂;

### 10 to 50 wt % B₂O₃;

### 15 to 50 wt % ZnO;

### 0 to 10 wt % Al₂O₃;

### 2 to 40 wt % Bi₂O₃;

### 0 to 5 wt % MgO;

### 5 to 38 wt % CaO+SrO+BaO;

more than 0.1 wt % but not more than 10 wt % Li₂O+Na₂O+K₂O;

### 0 to 4 wt % MoO₃; and

### 0 to 4 wt % WO₃, and

that the total of the contents of MoO₃ and WO₃ in the first glass is in a range of 0.1 to 8 wt %. As another example of glass having a more preferable composition, the first glass contains, as components thereof more than 2 wt % but not more than 15 wt % SiO₂;

### 10 to 50 wt % B₂O₃;

### 15 to 50 wt % ZnO;

### 0 to 10 wt % Al₂O₃;

### 2 to 40 wt % Bi₂O₃;

### 0 to 5 wt % MgO;

### 5 to 38 wt % CaO+SrO+BaO;

### 0.1 to 10 wt % Li₂O+Na₂O+K₂O;

### 0 to 4 wt % MoO₃; and

### 0 to 4 wt % WO₃, and

the total of the contents of MoO₃ and WO₃ in the first glass is in a range of 0.1 to 8 wt %.

Furthermore, as still another example of glass having a more preferable composition in the plasma display panel according to the present invention, the first glass contains, as components thereof more than 2 wt % but not more than 15 wt % SiO₂;

### 10 to 50 wt % B₂O₃;

### 15 to 50 wt % ZnO;

### 0 to 10 wt % Al₂O₃;

### 2 to 40 wt % Bi₂O₃;

### 0 to 5 wt % MgO;

### 5 to 38 wt % CaO+SrO+BaO;

more than 0.1 wt % but not more than 10 wt % Li₂O+Na₂O+K₂O;

### 0 to 4 wt % MoO₃; and

### 0 to 4 wt % WO₃, and

the total of the contents of MoO₃ and WO₃ in the first glass is in a range of 0.1 to 8 wt %.

In the first glass having the more preferable compositions as described above, the contents of Li₂O, Na₂O, and K₂O may be 0.17 wt % or less, 0.36 wt % or less, and 0.55 wt % or less, respectively, and the total of the contents of Li₂O, Na₂O, and K₂O may be 0.55 wt % or less.

The present invention further provides a method of producing a plasma display panel. This method includes forming a first dielectric layer that covers an electrode by placing a first glass material containing first glass on a substrate on which the electrode has been formed and baking the first glass material. In this method, the first glass contains Bi₂O₃, and the electrode that is covered with the first dielectric layer contains at least one selected from the group consisting of silver and copper. The first glass further contains 0 to 4 wt % of MoO₃ and 0 to 4 wt % of WO₃, and the total of the contents of MoO₃ and WO₃ in the first glass is in a range of 0.1 to 8 wt %.

In the plasma display panel according to the present invention and a plasma display panel obtained by the method of producing a plasma display panel according to the present invention (hereinafter each referred to as a plasma display panel obtained by the present invention), the first glass contains Bi₂O₃ as a component for obtaining glass with a lower softening point. Accordingly, it is possible to form a dielectric layer that is substantially free from lead (PbO). In the present specification, the phrase “substantially free” denotes that a trace amount of the component concerned that does not affect the properties is allowed to be contained. Specifically, it denotes that the content thereof is 0.1 wt % or less, and preferably 0.05 wt % or less. Hence, in the plasma display panel according to the present invention, the content of lead in the first glass can be 0.1 wt % or less, and preferably 0.05 wt % or less.

In the plasma display panel obtained by the present invention, the first glass that is contained in the first dielectric layer contains at least one selected from MoO₃ and WO₃. Accordingly, even if Ag or Cu that commonly is used as an electrode material ionizes and then diffuses in the dielectric layer, it produces a stable compound together with MoO₃ or WO₃, which prevents Ag or Cu from aggregating and becoming colloidal. This prevents the dielectric layer from yellowing due to the colloidal form of Ag or Cu. Similarly, in the case where the electrodes are formed on a glass substrate, Ag or Cu that has diffused in the glass substrate produces a stable compound together with MoO₃ or WO₃. Accordingly, the glass substrate also can be prevented from yellowing due to the colloidal form of Ag or Cu. Furthermore, the plasma display panel according to the present invention can prevent the occurrence of not only yellowing but also other harmful effects that accompany the production of Ag or Cu colloids, for example, a decrease in withstand voltage of the dielectric layer and a deterioration in luminance of the PDP.

In the plasma display panel obtained by the present invention, the first glass contains Bi₂O₃ (for example, the content of Bi₂O₃ is 2 to 40 wt %). Therefore, it is possible to obtain a plasma display panel in which a lead-free low softening point glass is contained in the dielectric layer covering the electrodes, as an alternative to glass containing lead.

Moreover, in the plasma display panel obtained by the present invention, the first glass can contain the suitable components as shown above. The first glass further can contain at least one selected from the group consisting of Li₂O, Na₂O and K₂O. This makes it possible not only to prevent the dielectric breakdown from occurring and the dielectric layer and the glass substrate from yellowing due to the colloidal form of Ag or Cu, but also to lower or adjust the softening point of the glass, thanks to at least one selected from the group consisting of Li₂O, Na₂O and K₂O. Moreover, the addition of these components (Li₂O, Na₂O and K₂O) having a function of lowering the softening point allows the content of Bi₂O₃, which is a component having a function of increasing the relative dielectric constant as well as the same function as the components (Li₂O, Na₂O and K₂O), to be reduced. Accordingly, the relative dielectric constant of the dielectric can be lowered or adjusted.

### BRIEF DESCRIPTION OF DRAWINGS

FIG. 1 is a cross-sectional view showing one embodiment of a PDP according to the present invention.

FIG. 2 is a cross-sectional view showing another embodiment of the PDP according to the present invention.

FIG. 3 is a partially cutaway perspective view showing a configuration of the PDP shown in FIG. 1.

FIG. 4 is a graph showing the relationship between the content of MoO₃ or WO₃ and the b* values.

### BEST MODE FOR CARRYING OUT THE INVENTION

Hereinafter, embodiments of the present invention are described. It should be noted, however, that the embodiments described below are merely examples of the present invention, and should not be construed to limit the scope of the present invention.

### <Plasma Display Panel>

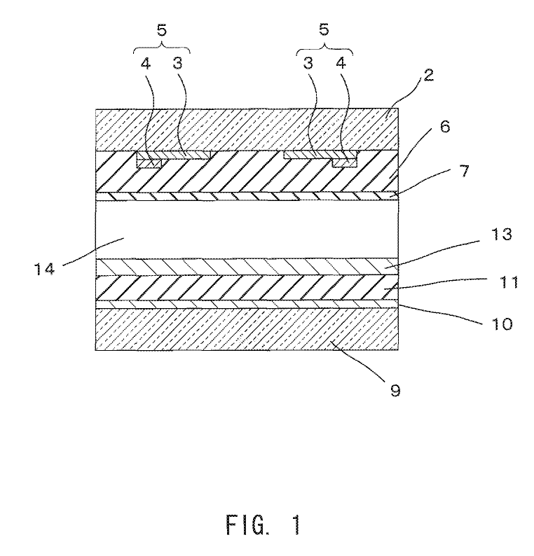

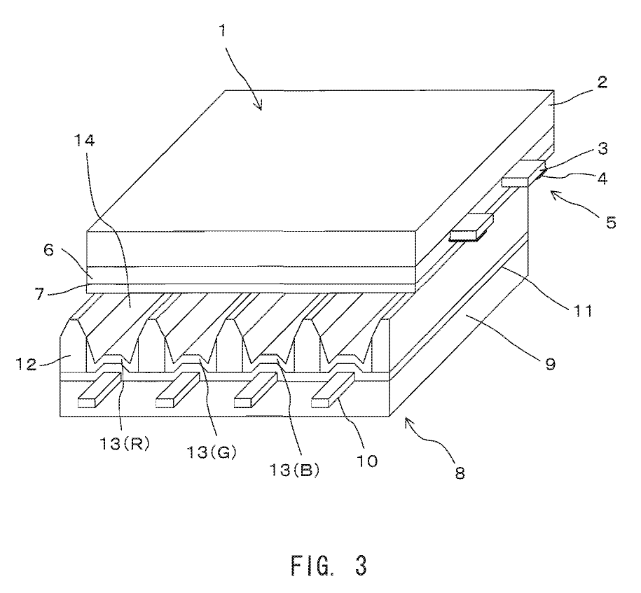

FIG. 3 is a partially cutaway perspective view showing the main configuration of the PDP according to the present embodiment. FIG. 1 is a cross-sectional view of the PDP shown in FIG. 3.

This PDP is of an AC surface discharge type and has a similar configuration to that of conventional PDPs except that a dielectric layer (a first dielectric layer) is formed of first glass to be described later.

This PDP is configured with a front panel 1 and a back panel 8 that are bonded to each other. The front panel 1 includes a front glass substrate 2, stripe-like display electrodes 5, a dielectric layer (a first dielectric layer) 6 that covers the display electrodes 5, and a dielectric-protective layer 7 made of magnesium oxide. Each of the display electrodes 5 is formed of a bus electrode 4 and a transparent conductive film 3 formed on the inner surface (the surface that is located on the side of discharge spaces 14) of the front glass substrate 2. The first glass to be described later is used for the dielectric layer 6.

The back panel 8 includes a back glass substrate 9, stripe-like address electrodes 10, a dielectric layer 11 that covers the address electrodes 10, belt-like barrier ribs 12, and phosphor layers 13, each of which is formed between barrier ribs 12 that are adjacent to each other. Each of the address electrodes 10 is formed on the inner surface (the surface that is located on the side of the discharge spaces 14) of the back glass substrate 9. Each of the barrier ribs 12 is provided on the dielectric layer 11 and is arranged between address electrodes 10 that are adjacent to each other. The barrier ribs 12 separate the respective address electrodes 10 from each other and thereby form the discharge spaces 14. In order to achieve a color display, the phosphor layers 13 include a red phosphor layer 13(R), a green phosphor layer 13(G), and a blue phosphor layer 13(B) that are arranged sequentially, with the barrier ribs 12 being interposed therebetween.

Materials such as those described below can be used for the phosphors that form the phosphor layers 13, for example.

Blue Phosphor: BaMgAl₁₀O₁₇:Eu

Green Phosphor Zn₂SiO₄:Mn

Red Phosphor: Y₂O₃:Eu

The front panel 1 and the back panel 8 are disposed so that the display electrodes 5 and the address electrodes 10 are orthogonal to each other in their longitudinal directions so as to oppose each other, and are joined to each other using a sealing member (not shown). The display electrodes 5 and the address electrodes 10 each are formed of a material containing at least one selected from silver (Ag) and copper (Cu).

The discharge spaces 14 are filled with a discharge gas (a filler gas) that includes rare gas components such as He, Xe, and Ne at a pressure of approximately 53.3 kPa to 79.8 kPa (400 to 600 Torr). Each of the display electrodes 5 is formed with the bus electrode 4 formed of a Ag film or a layered film of Cr/Cu/Cr being stacked on the transparent conductive film 3 made of ITO (indium tin oxide) or tin oxide in order to obtain good conductivity.

The display electrodes 5 and the address electrodes 10 each are connected to an external drive circuit (not shown). A voltage applied from the drive circuit allows electric discharge to occur in the discharge spaces 14. Ultraviolet rays with a short wavelength (a wavelength of 147 nm) that are generated due to the electric discharge excite the phosphors contained in the phosphor layers 13, and thereby visible light is emitted.

The dielectric layer 6 can be formed by applying a glass paste containing the first glass and baking it.

More specifically, a typical method of forming the dielectric layer 6 is a method of applying a glass paste, for example, by a screen method, or with a bar coater, a roll coater, a die coater, or a doctor blade, and then baking it. However, the method is not limited thereto. The dielectric layer 6 can be formed also by, for example, a method of attaching a sheet containing the first glass and baking it.

Preferably, the dielectric layer 6 has a thickness of 50 μm or less so as to ensure the optical transparency thereof, while having a thickness of at least 1 μm so as to ensure the insulation thereof. It is preferable that the thickness of the dielectric layer 6 is 3 μm to 50 μm, for example.

Although the details of the first glass contained in the dielectric layer 6 will be described later, the dielectric layer 6 contains at least one selected from MoO₃ and WO₃ in the present embodiment. Hence, even if a metal (for example, Ag or Cu) contained in the bus electrode 4 ionizes and then diffuses in the dielectric layer 6, it is prevented from forming metal colloids. Accordingly, the dielectric layer 6 is prevented from yellowing and suffering a decreased withstand voltage.

Furthermore, the problem of yellowing tends to arise apparently particularly when using glass that contains Bi₂O₃ or an alkali metal oxide as an alternative component to lead because the glass to be used should be substantially free from lead. In the present embodiment, however, since the dielectric layer 6 is formed of the glass that contains at least one selected from MoO₃ and WO₃, yellowing can be prevented from occurring. The glass that contains Bi₂O₃ particularly is effective in preventing yellowing. Hence, according to the present embodiment, it is possible to obtain the dielectric layer 6 that is free from lead and is prevented from yellowing.

Moreover, when the dielectric layer 6 is formed using the glass that contains at least one selected from MoO₃ and WO₃ as described above, the front glass substrate 2 also can be prevented from yellowing. Generally, a glass substrate to be used for a PDP is produced by a float process. The glass substrate produced by the float process contains Sn mixed into the surface thereof. This Sn reduces Ag ions and Cu ions to produce Ag and Cu colloids. Conventionally, it therefore is necessary to remove Sn by polishing the surface of the glass substrate produced by the float process. On the other hand, in the present embodiment, since at least one selected from MoO₃ and WO₃ that are contained in the dielectric layer 6 prevents Ag and Cu from becoming colloidal, the glass substrate can be used even if Sn remains on the surface thereof. Thus, it is no longer necessary to polish the glass substrate. This makes it possible to obtain an effect of reducing the number of production steps. The content of Sn that is contained (remains) in the glass substrate is 0.001 to 5 wt %, for example.

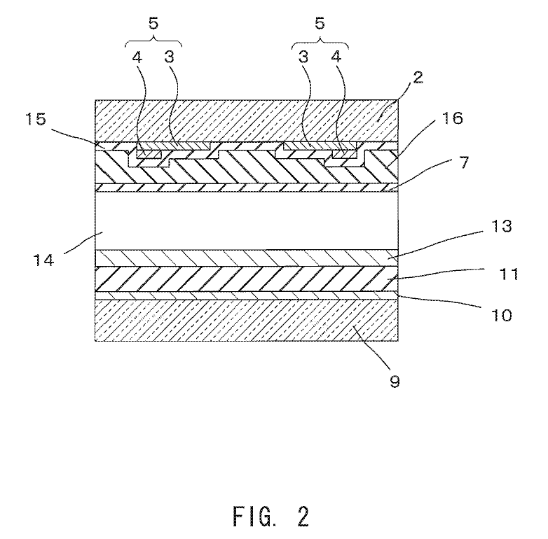

Next, an example of the PDP is described in which a dielectric layer that covers display electrodes 5 has a two-layer structure as shown in FIG. 2.

The PDP shown in FIG. 2 has the same configuration as that of the PDP shown in FIGS. 1 and 3, except that a first dielectric layer 15 that covers the display electrodes 5 and a second dielectric layer 16 disposed on the first dielectric layer 15 are provided instead of the dielectric layer 6. The members that are identical to those of the PDP shown in FIGS. 1 and 3 are indicated with the same numerals, and the descriptions thereof are not repeated.

As shown in FIG. 2, the first dielectric layer 15 and the second dielectric layer 16 are arranged so that the first dielectric layer 15 covers the transparent conductive films 3 and the bus electrodes 4 while the second dielectric layer 16 covers the first dielectric layer 15.

When the dielectric layer has the two-layer structure as described above, at least the first dielectric layer 15 contains the first glass containing at least one selected from MoO₃ and WO₃ and the total of the contents thereof is 0.1 to 8 wt %, as in the case of the dielectric layer 6 of the PDP shown in FIGS. 1 and 3. This can prevent at least the first dielectric layer 15 from yellowing and from having a decreased withstand voltage due to deposition of Ag or Cu colloids. Furthermore, the first dielectric layer 15 prevents Ag or Cu ions from diffusing. Hence, even if the second dielectric layer 16 contains glass having a composition that tends to undergo yellowing, the second dielectric layer 16 can be prevented from discoloring (yellowing) or from having a decreased withstand voltage.

Accordingly, any glass composition that meets the specifications required for the PDP can be selected to be used for the second dielectric layer 16, without having concerns about the problem of yellowing. Although the details of the second glass contained in the second dielectric layer 16 will be described later, for example, a SiO₂—B₂O₃—ZnO-based glass composition having a lower relative dielectric constant than that of lead glass and bismuth-based glass also can be used for the second dielectric layer 16 (the relative dielectric constant that is obtained at room temperature and 1 MHz generally is as follows: lead glass: 10 to 15, bismuth-based glass: 8 to 13, and SiO₂—B₂O₃—ZnO-based glass: 5 to 9). Hence, the use of the SiO₂—B₂O₃—ZnO-based glass composition for the second dielectric layer 16 allows the relative dielectric constant of the whole dielectric layer (i.e. the dielectric layer including the first dielectric layer 15 and the second dielectric layer 16) to decrease, and thereby the power consumption of the PDP can be reduced.

Such a dielectric layer having a two-layer structure can be formed by forming the first dielectric layer 15, then applying thereon a glass material containing a glass composition (second glass) to be used for the second dielectric layer 16, and baking it. In this case, it is preferable that the glass to be used for the first dielectric layer 15 has a higher softening point than that of the glass to be contained in the second dielectric layer.

In order to ensure the insulation and the prevention of interface reactions between the electrodes 3, 4 and the second dielectric layer 16, it is preferable that the thickness of the first dielectric layer 15 is at least 1 μm.

Preferably, the total thickness of the first dielectric layer 15 and the second dielectric layer 16 is 50 μm or less in order to prevent the loss of transmitted light, but is at least 3 μm in order to ensure the insulation.

As described above, the PDP according to the present embodiment further can include the second dielectric layer 16 provided on the first dielectric layer 15. The formation of the second dielectric layer 16 having desired properties that are different from those of the first dielectric layer 15 makes it possible to obtain a higher-performance PDP. For example, the use of a dielectric, for the second dielectric layer 16, having a smaller relative dielectric constant than that of the first dielectric layer 15 makes it possible to reduce the power consumption more than the use of only the first dielectric layer 15 as the dielectric layer. Furthermore, the use of a dielectric, for the second dielectric layer 16, having a higher transmittance than that of the first dielectric layer 15 makes it possible to improve the transmittance more than the use of only the first dielectric layer 15 as the dielectric layer.

In the PDP including the second dielectric layer 16, the second dielectric layer 16 may include the second glass and the second glass may contain, as components thereof, at least one selected from the group consisting of Li₂O, Na₂O, and K₂O. Thereby, the softening point of the second glass can be lowered or adjusted. Moreover, the addition of these components (at least one selected from the group consisting of Li₂O, Na₂O, and K₂O) having a function of lowering the softening point allows the content of Bi₂O₃, which is a component having a function of increasing the relative dielectric constant as well as the same function as the components (Li₂O, Na₂O and K₂O), to be reduced. Accordingly, the relative dielectric constant of the dielectric layer can be reduced or adjusted. A reduced relative dielectric constant of the dielectric layer makes it possible to realize a PDP having a reduced power consumption.

A PDP with a dielectric layer having a two-layer structure has been described in the present embodiment. However, even if the dielectric layer has a multi-layer structure including three or more layers, the dielectric layer can be prevented from yellowing and from having a decreased withstand voltage if the first dielectric layer 15 covering the display electrodes 5 contains the first glass that contains at least one selected from MoO₃ and WO₃ and the total of the contents thereof is 0.1 to 8 wt %.

In the present embodiment, the dielectric layer 6 and the first dielectric layer 15 that cover the display electrodes 5 on the front panel 1 have been described in detail. However, if the dielectric layer 11 that covers the address electrodes 10 in the back panel 8 is formed in the same manner as the dielectric layer 6 as described above, the dielectric layer 11 and the back glass substrate 9 can be prevented from coloring (yellowing) and from having a decreased withstand voltage. That is, when the glass contained in the dielectric layer 11 contains Bi₂O₃ and the address electrodes 10 contain at least one selected from silver and copper, as well as the glass further contains 0 to 4 wt % of MoO₃ and 0 to 4 wt % of WO₃ and the total of the contents of MoO₃ and WO₃ is in a range of 0.1 to 8 wt %, the above-mentioned effects such as the prevention of yellowing can be obtained.

As described above, in the PDP according to the present embodiment, the use of the above-mentioned first glass makes it possible to form a dielectric layer that is substantially free from lead and to prevent not only the display properties from deteriorating but also the withstand voltage from decreasing due to the discoloration (yellowing) of the dielectric layer.

A PDP to which the present invention is applied is typically a surface discharge type PDP as described in the present embodiment. However, the PDP to which the present invention is applied is not limited thereto. The present invention also is applicable to an opposed discharge type PDP.

Furthermore, the PDP to which the present invention is applied is not limited to AC type PDPs. The present invention also is applicable to a PDP provided with a dielectric layer even if the PDP is of a DC type.

### <First Glass>

The present invention is characterized through the finding of the glass composition of the dielectric layer that can prevent the glass substrate and the dielectric layer from yellowing. The first glass to be used for the dielectric layer (the first dielectric layer) that covers electrodes in the PDP according to the present invention is described below.

In the present embodiment, glass contained in the dielectric layer that covers electrodes contains Bi₂O₃ and further contains 0 to 4 wt % of MoO₃ and 0 to 4 wt % of WO₃, and the total of the contents of MoO₃ and WO₃ in the first glass is in a range of 0.1 to 8 wt %. This makes it possible to prevent the dielectric breakdown from occurring and the dielectric layer and the glass substrate from yellowing due to the colloidal form of Ag or Cu that is used for the electrodes.

These effects can be obtained when the electrodes contain Ag for the following reasons. It has been known that Ag and MoO₃ tend to produce compounds, such as Ag₂MoO₄, Ag₂Mo₂O₇, and Ag₂Mo₄O₁₃, at low temperatures, specifically at 580° C. or lower. Since the temperature at which the dielectric is baked is 550° C. to 600° C., it is conceivable that Ag⁺ that has diffused from the electrodes into the dielectric layer during the baking reacts with MoO₃ contained in the dielectric layer to produce the above-mentioned compounds and thereby is stabilized. That is, since Ag⁺ is stabilized without being reduced, it is prevented from aggregating and forming colloids. Similarly, Ag and WO₃ also tend to produce compounds, such as Ag₂WO₄, Ag₂W₂O₇, and Ag₂W₄O₁₃, and thereby Ag⁺ tends to be stabilized.

In a glass composition containing at least one selected from MoO₃ and WO₃, MoO₄²⁻ and/or WO₄²⁻ are/is present. Ag⁺ that has diffused from the electrodes during the baking combines with them and is stabilized. That is, it is conceivable that Ag⁺ is prevented not only from becoming colloidal but also from diffusing into the dielectric layer. Similarly, in the case where the electrodes contain Cu, it is conceivable that Cu⁺ is prevented from diffusing, resulting in the decrease of Cu that is to become colloidal and in the prevention of yellowing and a decrease in the withstand voltage.

In order to obtain the effects described above, the total of the contents of MoO₃ and WO₃ that are contained in the glass is at least 0.1 wt %.

Moreover, when the contents of MoO₃ and WO₃ in the glass increase, coloring of the glass that is caused by each of the MoO₃ and WO₃ becomes apparent. Hence, in order to prevent the transmittance of the dielectric layer from decreasing, the contents of MoO₃ and WO₃ each are 4 wt % or less. Furthermore, as compared to glass that contains only either MoO₃ or WO₃, glass that contains both MoO₃ and WO₃ makes it possible further reliably to obtain the effects of preventing the loss of transmittance and decreasing the degree of yellowing. Accordingly, it is more preferable to use glass containing both MoO₃ and WO₃. In the case of glass containing both MoO₃ and WO₃, the content of each can be up to the upper limit (4 wt %) thereof. Hence, the total of the contents of MoO₃ and WO₃ is 8 wt % or less.

In the above, the description is directed to the case where MoO₃ and/or WO₃ are/is mixed into the glass composition. However, mixed powder may be used that contains MoO₃ and/or WO₃ powder mixed into glass powder. When the mixed powder is placed on the electrodes and then is baked, some effect of decreasing the degree of yellowing can be obtained, although as compared to the case where MoO₃ and/or WO₃ are/is mixed into the glass composition, the homogeneity may deteriorate and thereby the transmittance of the dielectric layer may decrease in some cases.

The effect of decreasing the degree of yellowing that is provided by MoO₃ and WO₃ also is effective in the dielectric layer that is formed using glass containing PbO as a component thereof, which has been used conventionally. It, however, is more effective in the dielectric layer formed using glass that is substantially free from lead, that is, glass that contains 0.1 wt % or less of lead.

The reason is as follows. In order to obtain glass that is free from PbO, which is required conventionally for obtaining a lower softening point, it is necessary for the glass to contain an alkali metal oxide or bismuth oxide as an alternative component. Such components promote the diffusion of Ag or Cu and facilitate the reduction of ions, which increases the degree of yellowing. The effect of decreasing the degree of yellowing that is provided by MoO₃ and WO₃ is more prominent in the glass containing Bi₂O₃.

In the present embodiment, it is preferable that the glass contained in the dielectric layer that covers the electrodes contains, as components thereof

### 0 to 15 wt % SiO₂;

### 10 to 50 wt % B₂O₃;

### 15 to 50 wt % ZnO;

### 0 to 10 wt % Al₂O₃;

### 2 to 40 wt % Bi₂O₃;

### 0 to 5 wt % MgO;

### 5 to 38 wt % CaO+SrO+BaO;

### 0 to 4 wt % MoO₃; and

### 0 to 4 wt % WO₃, and

that the total of the contents of MoO₃ and WO₃ in the first glass is in a range of 0.1 to 8 wt %. Hereinafter, the composition described above also is referred to as glass (to be used for a dielectric layer) according to the present embodiment.

The glass according to the present embodiment further may contain, as components thereof, at least one selected from the group consisting of Li₂O, Na₂O, and K₂O. The total of the contents of Li₂O, Na₂O, and K₂O that are contained in the above glass can be 0.1 to 10 wt %, for example.

As an example of the composition of the glass for the dielectric layer according to the present embodiment, the first glass contains:

### 0 to 15 wt % SiO₂;

### 10 to 50 wt % B₂O₃;

### 15 to 50 wt % ZnO;

### 0 to 10 wt % Al₂O₃;

### 2 to 40 wt % Bi₂O₃;

### 0 to 5 wt % MgO;

### 5 to 38 wt % CaO+SrO+BaO;

more than 0.1 wt % but not more than 10 wt % Li₂O+Na₂O+K₂O;

### 0 to 4 wt % MoO₃; and

### 0 to 4 wt % WO₃, and

that the total of the contents of MoO₃ and WO₃ in the first glass is in a range of 0.1 to 8 wt %.

As another example of the composition of the glass for the dielectric layer according to the present embodiment, the first glass contains:

more than 2 wt % but not more than 15 wt % SiO₂;

### 10 to 50 wt % B₂O₃;

### 15 to 50 wt % ZnO;

### 0 to 10 wt % Al₂O₃;

### 2 to 40 wt % Bi₂O₃;

### 0 to 5 wt % MgO;

### 5 to 38 wt % CaO+SrO+BaO;

### 0.1 to 10 wt % Li₂O+Na₂O+K₂O;

### 0 to 4 wt % MoO₃; and

### 0 to 4 wt % WO₃, and

the total of the contents of MoO₃ and WO₃ in the first glass is in a range of 0.1 to 8 wt %.

As still another example of the composition of the glass for the dielectric layer according to the present embodiment, the first glass contains:

more than 2 wt % but not more than 15 wt % SiO₂;

### 10 to 50 wt % B₂O₃;

### 15 to 50 wt % ZnO;

### 0 to 10 wt % Al₂O₃;

### 2 to 40 wt % Bi₂O₃;

### 0 to 5 wt % MgO;

### 5 to 38 wt % CaO+SrO+BaO;

more than 0.1 wt % but not more than 10 wt % Li₂O+Na₂O+K₂O;

### 0 to 4 wt % MoO₃; and

### 0 to 4 wt % WO₃, and

the total of the contents of MoO₃ and WO₃ in the first glass is in a range of 0.1 to 8 wt %.

The details will be described later, but as an example of the composition for effectively preventing yellowing in a high-definition PDP, the contents of Li₂O, Na₂O, and K₂O in the glass to be used for the dielectric layer according to the present embodiment is 0.17 wt % or less, 0.36 wt % or less, and 0.55 wt % or less, respectively, and the total of the contents of Li₂O, Na₂O, and K₂O may be 0.55 wt % or less.

Hereinafter, the reasons for limiting these compositions (compositions of the glass according to the present embodiment) are described.

Although SiO₂ is not an essential component, it has an effect of stabilizing glass, and the content thereof preferably is 15 wt % or less. If the content of SiO₂ exceeds 15 wt %, the softening point increases, which may make it difficult to carry out baking at a predetermined temperature. The content of SiO₂ is more preferably 10 wt % or less. Furthermore, in order to allow fewer air bubbles to remain after baking, it is preferable that the glass has a lower viscosity at the time of the baking. For that purpose, it is preferable that the content of SiO₂ is 1 wt % or less. During the production, PDPs are subjected to heat treatment even after dielectric layers are formed. Therefore, if glass that forms a dielectric layer crystallizes, the transmittance of the dielectric layer may decrease or the dielectric layer may crack. In the case where the subsequent processes include more than one heat treatment processes, in order to prevent crystallization of glass, the content of SiO₂ preferably is more than 2 wt %, and more preferably 2.1 wt % or more. Moreover, the SiO₂ content in this range also allows the glass to improve its water-resistance, and thus it is possible to prevent the glass from deteriorating due to moisture absorption of glass powder during the production thereof. It is also possible to reduce moisture adsorption on the baked film and thereby prevent negative effects on the display performance of the panel.

B₂O₃ is an essential component of the glass to be used for the dielectric layer of the PDP according to the present embodiment. The content thereof is 10 to 50 wt %. The B₂O₃ content exceeding 50 wt % results in deteriorated durability of the glass as well as a decreased thermal expansion coefficient and an increased softening point of the glass. This causes difficulty in carrying out the baking at the predetermined temperature. On the other hand, when the B₂O₃ content is less than 10 wt %, the glass becomes unstable and tends to devitrify. The content of B₂O₃ is more preferably in the range of 15 to 50 wt %.

ZnO is one of the main components of the glass to be used for the dielectric layer of the PDP according to the present embodiment. ZnO has an effect of stabilizing glass. In the glass according to the present embodiment, the ZnO content is 15 to 50 wt %. When the ZnO content exceeds 50 wt %, glass tends to crystallize and therefore stable glass may not be obtained. On the other hand, when the ZnO content is less than 15 wt %, glass has a higher softening point and the baking therefore is difficult to carry out at the predetermined temperature. Furthermore, when the ZnO content is small, the glass tends to devitrify after the baking. Accordingly, in order to obtain stable glass, it is more preferable that the ZnO content is at least 26 wt %. Moreover, in order to reduce the discharge time lag that is a characteristic of a protective layer to be formed on the dielectric layer, the ZnO content preferably is at least 26 wt %, and more preferably at least 32 wt %.

Although Al₂O₃ is not an essential component, it has an effect of stabilizing glass, and the content thereof is 10 wt % or less. The Al₂O₃ content exceeding 10 wt % may cause devitrification of glass and also results in a higher softening point, which causes difficulty in baking glass at the predetermined temperature. Preferably, the Al₂O₃ content is 8 wt % or less but at least 0.01 wt %. When the Al₂O₃ content is at least 0.01 wt %, more stable glass can be obtained.

Bi₂O₃ is one of the main components of the glass to be used for the dielectric layer of the PDP according to the present embodiment. Bi₂O₃ has effects of lowering the softening point and increasing the thermal expansion coefficient. The content thereof is 2 to 40 wt %. When the Bi₂O₃ content exceeds 40 wt %, glass tends to crystallize. The Bi₂O₃ content exceeding 30 wt % results in a higher thermal expansion coefficient and also results in an excessively high dielectric constant, which increases the power consumption. On the other hand, the Bi₂O₃ content of less than 2 wt % results in a higher softening point, which causes difficulty in baking glass at the predetermined temperature. More preferably, the Bi₂O₃ content is in the range of 2 to 30 wt %.

Although MgO is not an essential component, it has an effect of stabilizing glass and the content thereof is 5 wt % or less. This is because the MgO content exceeding 5 wt % may cause devitrification during the production of glass.

The alkaline-earth metal oxides, CaO, SrO, and BaO, have effects of improving water resistance, preventing phase separation of glass, and improving the thermal expansion coefficient relatively, for example. The total of the contents thereof is 5 to 38 wt %. When the total of the contents of CaO, SrO, and BaO exceeds 38 wt %, glass may devitrify and may have an excessively high thermal expansion coefficient. On the other hand, when the total thereof is less than 5 wt %, the above-mentioned effects are difficult to obtain.

Preferably, the total of the contents of ZnO and Bi₂O₃ (i.e. ZnO+Bi₂O₃) is 35 to 65 wt %. In order to produce a dielectric that has a lower softening point and high transmittance and does not react with electrodes at a desired temperature that is 600° C. or lower, it is preferable that the total content (ZnO+Bi₂O₃) is at least 35 wt %. However, when the total content exceeds 65 wt %, a problem arises in that glass tends to crystallize.

Furthermore, it is preferable that a value of Bi₂O₃/(B₂O₃+ZnO), which is a ratio between the Bi₂O₃ content and the total of the contents of B₂O₃ and ZnO (i.e. B₂O₃+ZnO), is 0.5 or lower. Bi₂O₃ allows glass to have a higher dielectric constant as compared to B₂O₃ and ZnO. Accordingly, when the above-mentioned range is employed, a dielectric layer with a lower dielectric constant can be formed and thereby the power consumption can be reduced.

In order to prevent the dielectric layer from yellowing, it is preferable that the glass is free from the alkali metal oxides (Li₂O, Na₂O, and K₂O). However, since the glass according to the present embodiment contains at least one selected from MoO₃ and WO₃ that prevents yellowing, the glass may contain 0.1 to 10 wt % of at least one selected from Li₂O, Na₂O, and K₂O in addition to the above-mentioned composition. When the content of the alkali metal oxides in the glass is at least 0.1 wt %, the softening point can be lowered and various physical properties can be controlled. For instance, since the softening point can be lowered, the content of Bi₂O₃ that has the same effect can be reduced. This allows the relative dielectric constant to decrease. However, it is not preferable that the content of the alkali metal oxides exceed 10 wt % because in that case, the thermal expansion coefficient becomes excessively high.

When the surface of the dielectric layer is rough, transmitted light scatters, which may cause problems such as a decrease in the transmittance and a decrease in the display performance of the PDP. Accordingly, the dielectric layer that has been subjected to baking desirably has a good leveling property. In order to obtain a good leveling property, the total of the contents of Li₂O, Na₂O and K₂O (Li₂O+Na₂O+K₂O) preferably is more than 0.1 wt %, and more preferably at least 0.11 wt %.

On the other hand, since a higher-definition panel includes a large number of electrodes per unit area, yellowing tends to increase. In order to prevent yellowing of such a high-definition panel, it is preferable that the contents of alkali metal oxides are still lower. It is preferable that the content of Li₂O is 0.17 wt % or less when the glass contains Li₂O, the content of Na₂O is 0.36 wt % or less when the glass contains Na₂O, and the content of K₂O is 0.55 wt % or less when the glass contains K₂O. Furthermore, in order to prevent yellowing of a high-definition panel effectively, the total of the contents of Li₂O, Na₂O and K₂O preferably is 0.55 wt % or less, more preferably 0.36 wt % or less, and further preferably 0.17 wt % or less. Moreover, when the total of the contents of Li₂O, Na₂O and K₂O is in the above-mentioned range, it is also possible to obtain an effect of improving the water resistance of the glass. Accordingly, it is possible to prevent the glass from deteriorating due to moisture absorption of glass powder, in particular, during the production thereof. It is also possible to reduce moisture adsorption on the baked film and thereby prevent negative effects on the display performance of the panel.

The glass to be used for the dielectric layer according to the present embodiment contains the above-mentioned components and typically consists only of the above-mentioned components, respectively. They may contain other components as long as the advantageous effects of the present invention can be obtained. The total of the contents of other components preferably is 10 wt % or less, and more preferably 5 wt % or less. Examples of such other components include those to be added for controlling the softening point and thermal expansion coefficient, stabilizing glass, improving chemical durability, etc., specifically, Rb₂O, Cs₂O, TiO₂, ZrO₂, La₂O₃, Nb₂O₅, TeO₂, Ag₂O, SnO, CeO₂, CuO, and the like.

The glass to be used for the dielectric layer according to the present embodiment can be used as a material of a dielectric layer that is suitable for the glass substrate of the PDP. Examples of the glass substrate to be used commonly for a PDP include soda lime glass that is produced by a float process and generally is readily available window sheet glass, and high strain point glass that has been developed for PDPs. Such glass generally has a heat resistance up to 600° C. and a thermal expansion coefficient (a linear thermal expansion coefficient) of 75×10⁻⁷ to 85×10⁻⁷/° C.

The dielectric layer of the PDP is formed by applying a glass paste to a glass substrate and then baking it. It therefore is necessary to carry out the baking at a temperature of 600° C. or lower at which the glass substrate is not softened nor deformed. Furthermore, in order to prevent the glass substrate from warping and the dielectric layer from peeling off and cracking, the glass composition that forms the dielectric layer is required to have a lower thermal expansion coefficient than that of the glass substrate by approximately 0 to 25×10⁻⁷/° C. Moreover, when the dielectric layer has a high dielectric constant, the current that flows through the electrodes increases and thereby the power consumption of the PDP increases, which is not preferable.

For this reason, when the dielectric layer of the PDP is formed of lead-free glass that is substantially free from lead, it is preferable to use lead-free glass having a composition in the above-mentioned ranges, a softening point of 600° C. or lower, a thermal expansion coefficient of 60 to 85×10⁻⁷/° C., and a relative dielectric constant of 12 or lower. Furthermore, with consideration given to preventing peeling off and cracking that occur due to strain or the like and to achieving a yield of at least 90%, the thermal expansion coefficient is more preferably 65×10⁻⁷ to 85×10⁻⁷/° C. Moreover, in order to reduce the power consumption further, it is more preferable that the relative dielectric constant is 11 or lower.

The amount of the glass that is contained in the dielectric layer is not particularly limited, as long as the advantageous effects of the present invention are obtained. However, it usually is preferable that the amount of the glass is at least 50 wt % (for example, at least 80 wt % or at least 90 wt %). In one example, the dielectric layer may be formed substantially of glass alone. The glass components that compose the dielectric layer in the present embodiment are typically those of the glass having the above-mentioned compositions, and the glass components that are contained in the dielectric layer do not include lead.

In the PDP according to the present embodiment, when the dielectric layer of the front panel of the PDP is formed using the above-mentioned glass, an inorganic filler and an inorganic pigment may be added to improve the glass strength and to adjust the thermal expansion coefficient, without impairing the optical properties of the glass. Examples of the inorganic filler and inorganic pigment include alumina, titanium oxide, zirconia, zircon, cordierite, quartz, and the like.

The electrodes formed on the back panel of the PDP may be covered with the above-mentioned glass. Similarly in this case, an inorganic filler and an inorganic pigment may be added for the purposes of not only improving the optical properties such as reflectivity but also improving the glass strength and adjusting the thermal expansion coefficient. Examples of the inorganic filler and inorganic pigment include alumina, titanium oxide, zirconia, zircon, cordierite, and quartz.

### <Second Glass>

The glass (second glass) contained in the second dielectric layer is described specifically. The second dielectric layer is a layer that is not in contact with the electrodes when the dielectric layer has a two-layer structure as shown in FIG. 2. Preferably, this second glass contains at least one selected from Li₂O, Na₂O, and K₂O for the purposes of lowering the softening point and decreasing the relative dielectric constant. If the second dielectric layer is formed of glass that allows such a low relative dielectric constant to be obtained, the power consumption of the PDP can be reduced. Two examples of the second glass are described below.

In the present embodiment, the first example of the second glass to be used for forming the second dielectric layer contains, as components thereof

### 0 to 15 wt % SiO₂;

### 0 to 50 wt % B₂O₃;

### 10 to 50 wt % ZnO;

### 15 to 10 wt % Al₂O₃;

### 2 to 40 wt % Bi₂O₃;

### 0.1 to 10 wt % Li₂O+Na₂O+K₂O;

### 0 to 5 wt % MgO; and

### 5 to 38 wt % CaO+SrO+BaO.

In the present embodiment, the second example of the second glass to be used for forming the second dielectric layer contains, as components thereof.

### 0 to 30 wt % SiO₂;

### 25 to 80 wt % B₂O₃;

### 0 to 50 wt % ZnO;

### 0 to 10 wt % Al₂O₃;

### 5 to 20 wt % Li₂O+Na₂O+K₂O;

### 0 to 5 wt % MgO; and

### 0 to 15 wt % CaO+SrO+BaO.

Both the first and second examples of the glass allow not only a lower softening point but also a lower relative dielectric constant to be obtained. Particularly, the second example of the glass is substantially free from Bi₂O₃, which is a component to increase the relative dielectric constant, and therefore allows a lower relative dielectric constant to be obtained. Accordingly, when the second dielectric layer is formed using the first or second example of the second glass, the dielectric layer is allowed to have a lower dielectric constant, and thereby the power consumption of the PDP can be reduced.

### <Glass Paste>

The glass to be used for the dielectric layer of the PDP according to the present embodiment usually is used in powder form. A glass paste is obtained by adding a binder, a solvent, and the like, which are used for providing printability, to the glass powder according to the present embodiment described above. This glass paste is applied to the electrodes formed on the glass substrate and then is baked. Thus the dielectric layer that covers the electrodes can be formed. A protective layer with a predetermined thickness is formed on this dielectric layer using, for example, the electron-beam vapor deposition method. The method of forming the protective layer is not limited to the electron-beam vapor deposition method but may be a sputter method or an ion plating method.

The glass paste contains glass powder, a solvent, and resin (a binder). The glass powder is a powder of the glass composition to be used for the dielectric layer of the PDP according to the present invention described above. The glass paste also may contain components other than those mentioned above. For example, the glass paste may contain additives for various purposes. Examples of the additives include a surfactant, a development accelerator, an adhesive auxiliary, an antihalation agent, a preservation stabilizer, an antifoaming agent, an antioxidant, an ultraviolet absorber, pigments, dye, etc.

The resin (the binder) to be contained in the glass paste is not particularly limited as long as it has low reactivity to low-melting glass powder. From the viewpoints of chemical stability, cost, safety, etc., preferable examples of the resin include cellulose derivatives, such as nitrocellulose, methyl cellulose, ethyl cellulose, and carboxymethyl cellulose, polyvinyl alcohol, polyvinyl butyral, polyethylene glycol, carbonate-based resin, urethane-based resin, acryl-based resin, melamine-based resin, etc.

The solvent to be contained in the glass paste is not particularly limited as long as it has low reactivity to the glass powder. From the viewpoints of chemical stability, cost, safety, and compatibility with the binder resin, examples of the solvent include: butyl acetate; 3-ethoxy ethyl propionate; ethylene glycol monoalkyl ethers such as ethylene glycol monomethyl ether, ethylene glycol monoethyl ether, ethylene glycol monopropyl ether, and ethylene glycol monobutyl ether; ethylene glycol monoalkyl ether acetates such as ethylene glycol monomethyl ether acetate, and ethylene glycol monoethyl ether acetate; diethylene glycol dialkyl ethers such as diethylene glycol dimethyl ether, diethylene glycol diethyl ether, diethylene glycol dipropyl ether, and diethylene glycol dibutyl ether; propylene glycol monoalkyl ethers such as propylene glycol monomethyl ether, propylene glycol monoethyl ether, propylene glycol monopropyl ether, and propylene glycol monobutyl ether; propylene glycol dialkyl ethers such as propylene glycol dimethyl ether, propylene glycol diethyl ether, propylene glycol dipropyl ether, and propylene glycol dibutyl ether; propylene glycol alkyl ether acetates such as propylene glycol monomethyl ether acetate, propylene glycol monoethyl ether acetate, propylene glycol monopropyl ether acetate, and propylene glycol monobutyl ether acetate; esters of lactic acids such as methyl lactate, ethyl lactate, and butyl lactate; esters of aliphatic carboxylic acids such as methyl formate, ethyl formate, amyl formate, methyl acetate, ethyl acetate, propyl acetate, isopropyl acetate, isobutyl acetate, amyl acetate, isoamyl acetate, hexyl acetate, (2-ethylhexyl)acetate, methyl propionate, ethyl propionate, butyl propionate, methyl butanoate (methyl butyrate), ethyl butanoate (ethyl butyrate), propyl butanoate (propyl butyrate), and isopropyl butanoate (isopropyl butyrate); carbonates such as ethylene carbonate, and propylene carbonate; alcohols such as terpineol, and benzyl alcohol; aromatic hydrocarbons such as toluene, and xylene; ketones such as methyl ethyl ketone, 2-heptanone, 3-heptanone, 4-heptanone, and cyclohexanone; esters such as ethyl 2-hydroxypropionate, 2-hydroxy-2-methyl ethyl propionate, ethoxyethyl acetate, hydroxyethyl acetate, 2-hydroxy-3-methyl methyl butyrate, methyl 3-methoxypropionate, ethyl 3-methoxypropionate, 3-methoxybutyl acetate, 3-methyl-3-methoxybutyl acetate, butyl carbitol acetate, 3-methyl-3-methoxybutyl propionate, 3-methyl-3-methoxybutyl butyrate, 2,2,4-trimethyl-1,3-pentanediol monoisobutylate methyl acetoacetate, ethyl acetoacetate, methyl pyruvate, ethyl pyruvate, ethyl benzoate, and benzyl acetate; and amide-based solvents such as N-methylpyrrolidone, N,N-dimethylformamide, N-methylformamide, and N,N-dimethylacetamide. These solvents may be used alone, or two or more of them may be used in combination.

The content of the solvent in the glass paste is adjusted in the range that allows the plasticity or fluidity (viscosity) of the paste to be suitable for the forming process or coating process.

The glass paste also can be used to form the dielectric layer that covers the electrodes formed on the back panel of the PDP.

### <Production Method of PDP>

An example of the method of producing a PDP is described below. First, a method of producing the front panel is described.

A method of producing a PDP according to the present embodiment includes forming a dielectric layer (a first dielectric layer) that covers the electrodes by placing a glass material (a first glass material) containing first glass on a substrate on which the electrodes have been formed and baking this glass material. As the first glass to be used herein, the glass having the above-mentioned compositions can be used. Here, an example is described in which the above-mentioned process is employed in forming the dielectric layer that covers the display electrodes formed on the front panel.

First, a method of producing the front panel is described.

A plurality of transparent electrodes each are formed in a stripe shape on one main surface of a flat front glass substrate. Next, a silver paste is applied onto the transparent electrodes. Thereafter, the whole front glass substrate is heated and thereby the silver paste is baked to form bus electrodes. Thus, the display electrodes are formed.

Subsequently, the glass paste that contains the glass composition to be used for the dielectric layer of the PDP according to the present embodiment is applied to the above-mentioned main surface of the front glass substrate by a blade coater method so as to cover the display electrodes. Thereafter, the whole front glass substrate is maintained at 90° C. for 30 minutes and thereby the glass paste is dried, which then is baked at a temperature in the range of 560 to 590° C. for 10 minutes. Thus, the dielectric layer is formed.

The glass to be used herein for the dielectric layer is the glass described above.

Next, a film of magnesium oxide (MgO) is formed on the dielectric layer by an electron-beam vapor deposition method, which then is baked to form a protective layer.

Thus, the front panel is produced.

The method of producing a PDP whose dielectric layer has a two-layer structure as shown in FIG. 2 is as follows. Like the case described above, a glass paste that contains glass (first glass) to be used for the first dielectric layer is applied to cover the display electrodes and then is dried and baked. Thereafter, a glass paste that contains glass (second glass) to be used for the second dielectric layer is applied to cover the first dielectric layer formed as described above and then is dried and baked. Thus, the second dielectric layer is formed.

Next, a method of producing the back panel is described.

After a silver paste is applied to one main surface of the flat back glass substrate to form a plurality of stripes, the whole back glass substrate is heated, and thereby the silver paste is baked. Thus, address electrodes are formed.

Next, a glass paste is applied to the above-mentioned main surface of the back glass substrate by the blade coater method so as to cover the address electrodes. Thereafter, the whole front glass substrate is maintained at 90° C. for 30 minutes and thereby the glass paste is dried, which then is baked at a temperature in the range of 560 to 590° C. for 10 minutes. Thus, the dielectric layer is formed.

Here, as glass to be used for the dielectric layer, the above-mentioned glass to be used for the PDP according to the present embodiment can be used. In this case, the glass paste containing the above-mentioned glass is applied and then dried and baked, and thus the dielectric layer is formed.

Next, the glass paste is applied between adjacent address electrodes. The whole back glass substrate is then heated, and thereby the glass paste is baked. Thus, barrier ribs are formed.

Next, phosphor inks of respective R, G, and B colors are applied between adjacent barrier ribs. Then, the back glass substrate is heated to about 500° C. and thereby the above-mentioned phosphor inks are baked, and a resin component (a binder) and the like contained in the phosphor inks are removed. Thus, phosphor layers are formed.

Next, the front panel and the back panel are bonded to each other using sealing glass. Thereafter, the internal spaces thus sealed are evacuated to a high vacuum and then are charged with rare gas.

Thus, the PDP is obtained. The above-mentioned PDP and the method of producing it are merely examples, and the present invention is not limited thereto.

### EXAMPLES

Hereinafter, the present invention is described further in detail using examples.

### <Production and Evaluation of Glass>

Glass samples to be used for the dielectric layers of the PDP according to the present invention were produced. Tables 1 to 7 show the compositions of the glass samples to be used for dielectric layers of the PDP according to the present invention. Tables 8 to 11 show the compositions of the glass samples that were produced in order to examine the effect of decreasing the degree of yellowing through the addition of MoO₃ and WO₃ in the present invention. Glass samples shown in Tables 12 and 13 are the samples that can be used to describe the preferred contents of components in respective glass compositions to be used for the PDP according to the present invention. In the tables, “SiO₂” is indicated as “SiO₂”, for example.

TABLE 1

| Glass | No. | | | | | | | | | |
|---|---|---|---|---|---|---|---|---|---|---|
| Composition | 1 | 2 | 3 | 4 | 5 | 6 | 7 | 8 | 9 | 10 |
| SiO2 | 15.00 | 9.70 | 1.00 | 14.90 | 9.30 | | 12.00 | 1.60 | 1.50 | |
| B2O3 | 27.30 | 29.50 | 30.90 | 10.00 | 15.00 | 50.00 | 24.20 | 30.60 | 23.40 | 26.90 |
| ZnO | 27.00 | 26.80 | 26.00 | 33.60 | 35.70 | 26.00 | 15.00 | 31.80 | 39.70 | 50.00 |
| Al2O3 | 0.30 | 2.70 | 1.70 | 0.70 | 3.20 | 0.70 | 5.10 | 0.80 | 1.10 | 1.30 |
| Bi2O3 | 23.20 | 16.00 | 11.00 | 28.30 | 19.70 | 9.50 | 18.10 | 13.70 | 12.40 | 8.10 |
| MgO | | 1.20 | | | | | | | | |
| CaO | | 5.50 | 16.90 | 5.40 | | | | 1.30 | 5.50 | 2.60 |
| SrO | | | | 1.20 | 4.10 | | | | | 2.20 |
| BaO | 6.40 | 5.60 | 10.50 | 5.60 | 12.50 | 13.70 | 21.00 | 19.70 | 10.10 | 8.40 |
| Li2O | | | | | | | 1.20 | | | |
| Na2O | | | | | | | | | 1.30 | |
| K2O | | | | | | | 1.80 | | | |
| MoO3 | 0.80 | 3.00 | 2.00 | | | 0.10 | 0.60 | 0.50 | 2.00 | 0.50 |
| WO3 | | | | 0.30 | 0.50 | | 1.00 | | 3.00 | |
| Glass Transition | 492 | 493 | 485 | 491 | 492 | 469 | 489 | 477 | 480 | 473 |
| Point(° C.) | | | | | | | | | | |
| Softening | 593 | 589 | 581 | 590 | 588 | 572 | 598 | 574 | 576 | 569 |
| Point(° C.) | | | | | | | | | | |
| Thermal | 64 | 64 | 70 | 74 | 72 | 65 | 75 | 71 | 72 | 68 |
| Expansion | | | | | | | | | | |
| Coefficient | | | | | | | | | | |
| (×10⁻⁷/° C.) | | | | | | | | | | |
| Relative | 10.4 | 11.0 | 9.7 | 10.9 | 10.3 | 8.9 | 9.5 | 10.0 | 10.0 | 9.8 |
| Dielectric | | | | | | | | | | |
| Constant | | | | | | | | | | |
| Glass Stability | A | A | A | B | A | A | A | A | A | A |
| Overall | B | B | A | B | A | A | B | A | A | A |
| Evaluation | | | | | | | | | | |
| a* | −2.2 | −3.0 | −2.5 | −2.0 | −1.9 | −3.0 | −2.8 | −2.2 | −1.7 | −2.5 |
| b* | 3.1 | 2.2 | 2.4 | 3.5 | 3.2 | 4.5 | 2.6 | 2.9 | 1.8 | 3.9 |

TABLE 2

| Glass | No. | | | | | | | | | |
|---|---|---|---|---|---|---|---|---|---|---|
| Composition/ | 11 | 12 | 13 | 14 | 15 | 16 | 17 | 18 | 19 | 20 |
| SiO2 | 10.00 | | 1.20 | 1.60 | 1.10 | 3.80 | 3.50 | 4.00 | 5.60 | 2.00 |
| B2O3 | 25.20 | 31.10 | 24.30 | 24.20 | 35.40 | 27.50 | 28.00 | 15.50 | 18.60 | 30.60 |
| ZnO | 24.00 | 26.60 | 37.90 | 39.00 | 36.30 | 26.00 | 27.50 | 30.10 | 38.80 | 33.60 |
| Al2O3 | 10.00 | 8.00 | 0.10 | | 0.60 | 2.20 | 4.40 | 0.80 | 0.80 | 0.70 |
| Bi2O3 | 25.30 | 24.30 | 15.70 | 13.00 | 2.00 | 18.80 | 30.00 | 40.00 | 23.10 | 19.40 |
| MgO | | | | | | | | | 0.30 | 0.50 |
| CaO | 1.90 | 3.30 | 7.20 | 6.20 | 3.80 | 4.60 | 3.10 | 8.10 | 12.00 | 5.20 |
| SrO | | | 5.20 | 6.80 | 3.00 | | 1.80 | | | |
| BaO | 3.10 | 6.10 | 7.90 | 7.60 | 16.80 | 16.40 | 1.50 | | | 2.50 |
| Li2O | | | | | | | | | | 2.00 |
| Na2O | | | | 1.30 | | | | | | 1.50 |
| K2O | | | | | | | | | | |
| MoO3 | | 0.30 | | 0.30 | 1.00 | | 0.20 | 0.50 | 0.80 | 2.00 |
| WO3 | 0.50 | 0.30 | 0.50 | | | 0.70 | | 1.00 | | |
| Glass Transition | 490 | 475 | 472 | 479 | 490 | 488 | 461 | 470 | 489 | 472 |
| Point(° C.) | | | | | | | | | | |
| Softening | 595 | 582 | 571 | 580 | 592 | 590 | 566 | 565 | 579 | 570 |
| Point(° C.) | | | | | | | | | | |
| Thermal | 64 | 65 | 72 | 73 | 70 | 72 | 72 | 85 | 80 | 68 |
| Expansion | | | | | | | | | | |
| Coefficient | | | | | | | | | | |
| (×10⁻⁷/° C.) | | | | | | | | | | |
| Relative | 10.7 | 10.3 | 10.1 | 10.0 | 8.2 | 10.2 | 10.8 | 12.0 | 11.0 | 10.4 |
| Dielectric | | | | | | | | | | |
| Constant | | | | | | | | | | |
| Glass Stability | B | A | A | B | A | A | A | A | A | A |
| Overall | B | A | A | B | A | A | A | B | A | A |
| Evaluation | | | | | | | | | | |
| a* | −2.5 | −1.9 | −2.0 | −1.7 | −1.8 | −2.2 | −2.0 | −2.1 | −1.8 | −2.2 |
| b* | 2.9 | 2.0 | 2.2 | 2.4 | 2.0 | 2.5 | 2.3 | 2.5 | 2.0 | 2.4 |

TABLE 3

| Glass | No. | | | | | | | | | |
|---|---|---|---|---|---|---|---|---|---|---|
| Composition/ | 21 | 22 | 23 | 24 | 25 | 26 | 27 | 28 | 29 | 30 |
| SiO2 | 2.70 | 2.50 | 0.80 | 3.40 | 0.80 | 3.20 | 0.30 | 1.40 | 0.60 | 4.50 |
| B2O3 | 32.10 | 37.70 | 29.00 | 36.00 | 29.50 | 33.70 | 26.70 | 32.80 | 28.40 | 17.50 |
| ZnO | 31.10 | 27.60 | 27.10 | 28.60 | 26.40 | 32.60 | 30.20 | 32.10 | 27.80 | 35.00 |
| Al2O3 | 0.30 | 0.30 | 0.60 | 0.70 | 0.80 | 0.50 | 0.50 | 1.50 | 1.00 | |
| Bi2O3 | 23.00 | 26.40 | 3.80 | 25.80 | 3.80 | 24.50 | 3.60 | 26.70 | 3.50 | 29.90 |
| MgO | 5.00 | | | | | | | | | |
| CaO | 4.30 | 5.00 | 38.00 | | | | | 2.50 | 10.80 | 10.70 |
| SrO | | | | 5.00 | 38.00 | | | 0.90 | 4.90 | |
| BaO | 1.00 | | | | | 5.00 | 38.00 | 1.60 | 22.30 | |
| Li2O | | | | | | | | | | 0.10 |
| Na2O | | | | | | | | | | |
| K2O | | | | | | | | | | |
| MoO3 | 0.50 | 0.50 | | 0.50 | | 0.50 | | 0.50 | | 1.00 |
| WO3 | | | 0.70 | | 0.70 | | 0.70 | | 0.70 | 1.30 |
| Glass Transition | 469 | 470 | 487 | 467 | 491 | 465 | 492 | 461 | 492 | 480 |
| Point(° C.) | | | | | | | | | | |
| Softening | 572 | 573 | 585 | 570 | 590 | 568 | 592 | 562 | 590 | 569 |
| Point(° C.) | | | | | | | | | | |
| Thermal | 62 | 64 | 83 | 63 | 84 | 64 | 80 | 63 | 81 | 80 |
| Expansion | | | | | | | | | | |
| Coefficient | | | | | | | | | | |
| (×10⁻⁷/° C.) | | | | | | | | | | |
| Relative | 10.5 | 10.7 | 8.6 | 10.8 | 9.1 | 10.8 | 9.6 | 10.8 | 9.4 | 10.8 |
| Dielectric | | | | | | | | | | |
| Constant | | | | | | | | | | |
| Glass Stability | A | A | B | A | B | A | B | A | B | A |
| Overall | B | B | B | B | B | B | B | B | B | A |
| Evaluation | | | | | | | | | | |
| a* | −2.3 | −2.4 | −2.4 | −2.2 | −2.6 | −2.3 | −2.5 | −2.2 | −2.4 | −2.0 |
| b* | 2.8 | 2.7 | 3.0 | 2.8 | 3.3 | 2.8 | 3.1 | 2.7 | 3.0 | 2.9 |

TABLE 4

| Glass | No. | | | | | |
|---|---|---|---|---|---|---|
| Composition/ | 31 | 32 | 33 | 34 | 35 | 36 |
| SiO2 | 5.60 | 4.50 | 5.60 | 4.50 | 5.60 | 5.60 |
| B2O3 | 18.00 | 17.50 | 18.00 | 17.50 | 18.00 | 18.00 |
| ZnO | 31.20 | 35.00 | 31.20 | 35.00 | 31.20 | 31.20 |
| Al2O3 | 0.90 | | 0.90 | | 0.90 | 0.90 |
| Bi2O3 | 25.50 | 29.90 | 25.50 | 29.90 | 25.50 | 25.50 |
| MgO | | | | | | |
| CaO | 8.00 | 10.70 | 8.00 | 10.70 | 8.00 | 8.00 |
| SrO | | | | | | |
| BaO | | | | | | |
| Li2O | 10.00 | | | | | 2.00 |
| Na2O | | 0.10 | 10.00 | | | 3.00 |
| K2O | | | | 0.10 | 10.00 | 5.00 |
| MoO3 | 0.80 | 1.00 | 0.80 | 1.00 | 0.80 | 0.80 |
| WO3 | | 1.30 | | 1.30 | | |
| Glass | 475 | 480 | 477 | 481 | 475 | 475 |
| Transition | | | | | | |
| Point(° C.) | | | | | | |
| Softening | 565 | 570 | 567 | 570 | 571 | 572 |
| Point(° C.) | | | | | | |
| Thermal | 83 | 80 | 83 | 81 | 84 | 84 |
| Expansion | | | | | | |
| Coefficient | | | | | | |
| (×10⁻⁷/° C.) | | | | | | |
| Relative | 10.7 | 11.0 | 10.6 | 11.0 | 10.7 | 10.5 |
| Dielectric | | | | | | |
| Constant | | | | | | |
| Glass Stability | A | A | A | A | A | A |
| Overall | A | A | A | A | A | A |
| Evaluation | | | | | | |
| a* | −2.2 | −1.8 | −2.2 | −2.0 | −2.0 | −2.4 |
| b* | 4.1 | 3.0 | 4.6 | 2.9 | 4.2 | 4.3 |

TABLE 5

| Glass | No. | | | | | | | | |
|---|---|---|---|---|---|---|---|---|---|
| Composition/ | 37 | 38 | 39 | 40 | 41 | 42 | 43 | 44 | 45 |
| SiO2 | 15.00 | 9.70 | 1.00 | 14.35 | 9.30 | | 2.10 | | 10.00 |
| B2O3 | 27.30 | 29.40 | 30.79 | 10.00 | 15.00 | 50.00 | 30.10 | 26.90 | 25.10 |
| ZnO | 27.00 | 26.79 | 26.00 | 33.60 | 35.70 | 26.00 | 31.65 | 50.00 | 23.90 |
| Al2O3 | 0.30 | 2.70 | 1.70 | 0.70 | 3.20 | 0.55 | 0.80 | 1.30 | 10.00 |
| Bi2O3 | 23.00 | 16.00 | 11.00 | 28.30 | 19.70 | 9.50 | 13.70 | 8.10 | 25.14 |
| MgO | | 1.20 | | | | | | | |
| CaO | | 5.50 | 16.90 | 5.40 | | | 1.30 | 2.60 | 1.90 |
| SrO | | | | 1.20 | 4.10 | | | 2.20 | |
| BaO | 6.40 | 5.60 | 10.50 | 5.60 | 12.39 | 13.70 | 19.70 | 8.10 | 3.10 |
| Li2O | | 0.11 | 0.05 | 0.10 | | | 0.05 | | 0.05 |
| Na2O | | | 0.06 | 0.18 | 0.11 | | 0.10 | 0.10 | 0.12 |
| K2O | 0.20 | | | 0.27 | | 0.15 | | 0.20 | 0.19 |
| MoO3 | 0.80 | 3.00 | 2.00 | | | 0.10 | 0.50 | 0.50 | |
| WO3 | | | | 0.30 | 0.50 | | | | 0.50 |
| Glass Transition | 490 | 491 | 484 | 488 | 491 | 467 | 478 | 470 | 490 |
| Point(° C.) | | | | | | | | | |
| Softening | 591 | 588 | 581 | 586 | 588 | 570 | 575 | 566 | 593 |
| Point(° C.) | | | | | | | | | |
| Thermal | 64 | 65 | 70 | 75 | 72 | 65 | 72 | 69 | 64 |
| Expansion | | | | | | | | | |
| Coefficient | | | | | | | | | |
| (×10⁻⁷/° C.) | | | | | | | | | |
| Relative | 10.4 | 11.0 | 9.8 | 11.2 | 10.3 | 8.9 | 10.1 | 9.8 | 10.8 |
| Dielectric | | | | | | | | | |
| Constant | | | | | | | | | |
| Glass Stability | A | A | A | B | A | A | A | A | B |
| Overall | B | A | A | B | A | A | A | A | B |
| Evaluation | | | | | | | | | |
| a* | −2.2 | −3.0 | −2.5 | −2.1 | −1.8 | −3.0 | −2.3 | −2.4 | −2.5 |
| b* | 3.2 | 2.5 | 2.5 | 3.6 | 3.3 | 4.5 | 3.0 | 4.0 | 3.0 |

TABLE 6

| Glass | No. | | | | | | | | |
|---|---|---|---|---|---|---|---|---|---|
| Composition/ | 46 | 47 | 48 | 49 | 50 | 51 | 52 | 53 | 54 |
| SiO2 | | 1.20 | 1.10 | 3.80 | 3.50 | 4.00 | 5.60 | 2.70 | 2.50 |
| B2O3 | 31.10 | 24.30 | 35.40 | 27.40 | 28.00 | 15.50 | 18.60 | 32.10 | 37.70 |
| ZnO | 26.60 | 37.90 | 36.30 | 26.00 | 27.50 | 29.90 | 38.80 | 31.10 | 27.60 |
| Al2O3 | 8.00 | 0.10 | 0.60 | 2.20 | 4.40 | 0.80 | 0.80 | 0.30 | 0.30 |
| Bi2O3 | 24.15 | 15.70 | 2.00 | 18.79 | 30.00 | 40.00 | 22.90 | 22.89 | 26.25 |
| MgO | | | | | | | 0.30 | 5.00 | |
| CaO | 3.30 | 7.20 | 3.80 | 4.60 | 2.93 | 8.10 | 12.00 | 4.30 | 5.00 |
| SrO | | 5.20 | 3.00 | | 1.80 | | | | |
| BaO | 6.10 | 7.75 | 16.20 | 16.40 | 1.50 | | | 1.00 | |
| Li2O | | | 0.10 | | 0.05 | | | | |
| Na2O | 0.05 | 0.05 | 0.20 | | 0.05 | 0.20 | 0.10 | | 0.05 |
| K2O | 0.10 | 0.10 | 0.30 | 0.11 | 0.07 | | 0.10 | 0.11 | 0.10 |
| MoO3 | 0.30 | | 1.00 | 0.70 | 0.20 | 0.50 | 0.80 | 0.50 | 0.50 |
| WO3 | 0.30 | 0.50 | | | | 1.00 | | | |
| Glass Transition | 474 | 472 | 488 | 486 | 460 | 469 | 488 | 469 | 470 |
| Point(° C.) | | | | | | | | | |
| Softening | 582 | 570 | 590 | 588 | 564 | 564 | 577 | 570 | 572 |
| Point(° C.) | | | | | | | | | |
| Thermal | 65 | 72 | 71 | 72 | 72 | 85 | 80 | 62 | 64 |
| Expansion | | | | | | | | | |
| Coefficient | | | | | | | | | |
| (×10⁻⁷/° C.) | | | | | | | | | |
| Relative | 10.3 | 10.1 | 8.3 | 10.3 | 10.8 | 12.0 | 11.0 | 10.5 | 10.7 |
| Dielectric | | | | | | | | | |
| Constant | | | | | | | | | |
| Glass Stability | A | A | A | A | A | B | A | A | A |
| Overall | A | A | A | A | A | B | A | B | B |
| Evaluation | | | | | | | | | |
| a* | −1.9 | −2.0 | −1.9 | −2.2 | −2.0 | −2.1 | −1.9 | −2.3 | −2.3 |
| b* | 2.1 | 2.2 | 2.2 | 2.5 | 2.4 | 2.6 | 2.1 | 2.8 | 2.8 |

TABLE 7

| Glass | No. | | | | | | | | | |
|---|---|---|---|---|---|---|---|---|---|---|
| Composition/ | 55 | 56 | 57 | 58 | 59 | 60 | 61 | 62 | 63 | 64 |
| SiO2 | 0.80 | 3.40 | 0.80 | 3.20 | 0.30 | 1.40 | 0.60 | 6.19 | 6.00 | 6.00 |
| B2O3 | 28.50 | 36.00 | 29.00 | 33.70 | 26.20 | 32.85 | 28.40 | 18.70 | 18.70 | 18.70 |
| ZnO | 27.10 | 28.60 | 26.40 | 32.60 | 30.20 | 32.10 | 27.60 | 38.93 | 38.93 | 38.93 |
| Al2O3 | 0.60 | 0.70 | 0.80 | 0.50 | 0.50 | 1.50 | 1.00 | 0.51 | 0.51 | 0.51 |
| Bi2O3 | 3.80 | 25.65 | 3.80 | 24.35 | 3.60 | 26.70 | 3.50 | 23.10 | 23.10 | 22.91 |
| MgO | | | | | | | | | | |
| CaO | 38.00 | | | | | 2.50 | 10.80 | 5.50 | 5.50 | 5.50 |
| SrO | | 5.00 | 38.00 | | | 0.90 | 4.90 | 6.50 | 6.50 | 6.50 |
| BaO | | | | 5.00 | 38.00 | 1.60 | 22.30 | | | |
| Li2O | 0.10 | | 0.10 | | 0.10 | | | 0.17 | | |
| Na2O | 0.20 | 0.05 | 0.20 | 0.05 | 0.20 | | | | 0.36 | |
| K2O | 0.20 | 0.10 | 0.20 | 0.10 | 0.20 | 0.15 | 0.20 | | | 0.55 |
| MoO3 | | 0.50 | | 0.50 | | 0.50 | | 0.40 | 0.40 | 0.40 |
| WO3 | 0.70 | | 0.70 | | 0.70 | | 0.70 | | | |
| Glass Transition | 486 | 467 | 489 | 465 | 490 | 461 | 490 | 483 | 482 | 481 |
| Point(° C.) | | | | | | | | | | |
| Softening | 583 | 568 | 587 | 568 | 590 | 560 | 590 | 577 | 575 | 574 |
| Point(° C.) | | | | | | | | | | |
| Thermal | 83 | 63 | 85 | 64 | 81 | 63 | 81 | 76 | 78 | 78 |
| Expansion | | | | | | | | | | |
| Coefficient | | | | | | | | | | |
| (×10⁻⁷/° C.) | | | | | | | | | | |
| Relative | 8.7 | 10.8 | 9.3 | 10.8 | 9.6 | 10.9 | 9.4 | 10.8 | 10.9 | 11.0 |
| Dielectric | | | | | | | | | | |
| Constant | | | | | | | | | | |
| Glass Stability | B | A | B | A | B | A | B | A | A | A |
| Overall | B | B | B | B | B | B | B | A | A | A |
| Evaluation | | | | | | | | | | |
| a* | −2.4 | −2.2 | −2.7 | −2.3 | −2.5 | −2.2 | −2.4 | −1.9 | −1.9 | −2.0 |
| b* | 3.2 | 2.8 | 3.5 | 2.9 | 3.3 | 2.8 | 3.2 | 2.7 | 2.7 | 2.8 |

TABLE 8

| Glass | No. | | | | | | | |
|---|---|---|---|---|---|---|---|---|
| Composition/ | 71 | 72 | 73 | 74 | 75 | 76 | 77 | 78 |
| SiO2 | 3.10 | 3.10 | 3.10 | 3.09 | 3.07 | 3.01 | 2.98 | 2.95 |
| B2O3 | 17.50 | 17.49 | 17.48 | 17.45 | 17.33 | 16.98 | 16.80 | 16.63 |
| ZnO | 35.00 | 34.98 | 34.97 | 34.89 | 34.64 | 33.94 | 33.60 | 33.24 |
| Al2O3 | 0.50 | 0.50 | 0.50 | 0.50 | 0.49 | 0.49 | 0.48 | 0.48 |
| Bi2O3 | 31.40 | 31.39 | 31.37 | 31.31 | 31.09 | 30.45 | 30.14 | 29.82 |
| CaO | 12.50 | 12.49 | 12.48 | 12.46 | 12.38 | 12.13 | 12.00 | 11.88 |
| MoO3 | | 0.05 | 0.10 | 0.30 | 1.00 | 3.00 | 4.00 | 5.00 |
| WO3 | | | | | | | | |
| Glass Transition | 472 | 472 | 472 | 473 | 474 | 476 | 479 | 479 |
| Point(° C.) | | | | | | | | |
| Softening | 569 | 569 | 570 | 570 | 572 | 574 | 577 | 578 |
| Point(° C.) | | | | | | | | |
| Thermal | 82 | 82 | 82 | 82 | 82 | 83 | 83 | 83 |
| Expansion | | | | | | | | |
| Coefficient | | | | | | | | |
| (×10⁻⁷/° C.) | | | | | | | | |
| Relative | 11.8 | 11.7 | 11.7 | 11.8 | 11.8 | 11.9 | 11.9 | 11.9 |
| Dielectric | | | | | | | | |
| Constant | | | | | | | | |
| Glass Stability | A | A | A | A | A | A | A | B |
| Overall | B | B | B | B | B | B | B | D |
| Evaluation | | | | | | | | |
| a* | −2.1 | −2.1 | −2.1 | −2.2 | −2.2 | −2.2 | −2.2 | — |
| b* | 6.1 | 6.0 | 4.9 | 4.1 | 3.0 | 2.4 | 2.2 | — |

TABLE 9

| Glass | No. | | | | | | | | |
|---|---|---|---|---|---|---|---|---|---|
| Composition/ | 79 | 80 | 81 | 82 | 83 | 84 | 85 | 86 | 87 |
| SiO2 | 3.10 | 3.10 | 3.09 | 3.07 | 3.01 | 2.98 | 2.95 | 2.91 | 2.85 |
| B2O3 | 17.49 | 17.48 | 17.45 | 17.33 | 16.98 | 16.80 | 16.63 | 16.45 | 16.10 |
| ZnO | 34.98 | 34.97 | 34.89 | 34.64 | 33.94 | 33.60 | 33.24 | 32.90 | 32.20 |
| Al2O3 | 0.50 | 0.50 | 0.50 | 0.49 | 0.49 | 0.48 | 0.48 | 0.47 | 0.46 |
| Bi2O3 | 31.39 | 31.37 | 31.31 | 31.09 | 30.45 | 30.14 | 29.82 | 29.52 | 28.89 |
| CaO | 12.49 | 12.48 | 12.46 | 12.38 | 12.13 | 12.00 | 11.88 | 11.75 | 11.50 |
| MoO3 | | | | | | | | 3.00 | 4.00 |
| WO3 | 0.05 | 0.10 | 0.30 | 1.00 | 3.00 | 4.00 | 5.00 | 3.00 | 4.00 |
| Glass Transition | 472 | 472 | 472 | 474 | 477 | 478 | 480 | 480 | 482 |
| Point(° C.) | | | | | | | | | |
| Softening | 569 | 569 | 570 | 571 | 573 | 575 | 577 | 581 | 584 |
| Point(° C.) | | | | | | | | | |
| Thermal | 82 | 82 | 82 | 82 | 83 | 82 | 83 | 83 | 84 |
| Expansion | | | | | | | | | |
| Coefficient | | | | | | | | | |
| (×10⁻⁷/° C.) | | | | | | | | | |
| Relative | 11.7 | 11.8 | 11.8 | 11.8 | 11.8 | 11.9 | 11.9 | 12.0 | 12.0 |
| Dielectric | | | | | | | | | |
| Constant | | | | | | | | | |
| Glass Stability | A | A | A | A | A | A | B | A | A |
| Overall | B | B | B | B | B | B | D | B | B |
| Evaluation | | | | | | | | | |
| a* | −2.1 | −2.1 | −2.1 | −2.2 | −2.2 | −2.3 | — | −2.4 | −2.4 |
| b* | 6.1 | 5.0 | 4.5 | 3.8 | 2.9 | 2.7 | — | 2.0 | 1.8 |

TABLE 10

| Glass | No. | | | | | | | |
|---|---|---|---|---|---|---|---|---|
| Composition/ | 88 | 89 | 90 | 91 | 92 | 93 | 94 | 95 |
| SiO2 | 4.00 | 4.00 | 4.00 | 3.99 | 3.96 | 3.88 | 3.84 | 3.80 |
| B2O3 | 20.66 | 20.65 | 20.64 | 20.60 | 20.46 | 20.04 | 19.84 | 19.63 |
| ZnO | 37.28 | 37.26 | 37.25 | 37.17 | 36.90 | 36.16 | 35.78 | 35.42 |
| Al2O3 | 0.23 | 0.23 | 0.23 | 0.23 | 0.23 | 0.22 | 0.22 | 0.22 |
| Bi2O3 | 27.14 | 27.13 | 27.11 | 27.06 | 26.87 | 26.33 | 26.06 | 25.78 |
| CaO | 10.55 | 10.54 | 10.53 | 10.51 | 10.44 | 10.23 | 10.12 | 10.02 |
| K2O | 0.14 | 0.14 | 0.14 | 0.14 | 0.14 | 0.14 | 0.14 | 0.13 |
| MoO3 | | 0.05 | 0.10 | 0.30 | 1.00 | 3.00 | 1.00 | 5.00 |
| WO3 | | | | | | | | |
| Glass Transition | 483 | 483 | 484 | 485 | 486 | 487 | 487 | 489 |
| Point(° C.) | | | | | | | | |
| Softening | 570 | 571 | 571 | 572 | 573 | 575 | 576 | 578 |
| Point(° C.) | | | | | | | | |
| Thermal | 75 | 75 | 76 | 76 | 77 | 78 | 78 | 79 |
| Expansion | | | | | | | | |
| Coefficient | | | | | | | | |
| (×10⁻⁷/° C.) | | | | | | | | |
| Relative | 11.1 | 11.1 | 11.2 | 11.3 | 11.4 | 11.6 | 11.6 | 11.8 |
| Dielectric | | | | | | | | |
| Constant | | | | | | | | |
| Glass Stability | A | A | A | A | A | A | A | B |
| Overall | B | B | B | B | B | B | B | D |
| Evaluation | | | | | | | | |
| a* | −2.0 | −2.0 | −1.9 | −2.0 | −1.9 | −2.0 | −2.1 | — |
| b* | 5.8 | 5.7 | 4.7 | 4.1 | 3.3 | 2.9 | 2.8 | — |

TABLE 11

| Glass | No. | | | | | | | | |
|---|---|---|---|---|---|---|---|---|---|
| Composition/ | 96 | 97 | 98 | 99 | 100 | 101 | 102 | 103 | 104 |
| SiO2 | 4.00 | 4.00 | 3.99 | 3.96 | 3.88 | 3.84 | 3.80 | 3.76 | 3.68 |
| B2O3 | 20.65 | 20.64 | 20.60 | 20.46 | 20.04 | 19.84 | 19.63 | 19.42 | 19.01 |
| ZnO | 37.26 | 37.25 | 37.17 | 36.90 | 36.16 | 35.78 | 35.42 | 35.06 | 34.30 |
| Al2O3 | 0.23 | 0.23 | 0.23 | 0.23 | 0.22 | 0.22 | 0.22 | 0.21 | 0.21 |
| Bi2O3 | 27.13 | 27.11 | 27.06 | 26.87 | 26.33 | 26.06 | 25.78 | 25.51 | 24.97 |
| CaO | 10.54 | 10.53 | 10.51 | 10.44 | 10.23 | 10.12 | 10.02 | 9.91 | 9.70 |
| K2O | 0.14 | 0.14 | 0.14 | 0.14 | 0.14 | 0.14 | 0.13 | 0.13 | 0.13 |
| MoO3 | | | | | | | | 3.00 | 4.00 |
| WO3 | 0.05 | 0.10 | 0.30 | 1.00 | 3.00 | 4.00 | 5.00 | 3.00 | 4.00 |
| Glass Transition | 483 | 483 | 484 | 484 | 486 | 486 | 487 | 488 | 490 |
| Point(° C.) | | | | | | | | | |
| Softening | 570 | 571 | 571 | 572 | 574 | 576 | 577 | 579 | 582 |
| Point(° C.) | | | | | | | | | |
| Thermal | 76 | 77 | 77 | 77 | 78 | 79 | 79 | 80 | 80 |
| Expansion | | | | | | | | | |
| Coefficient | | | | | | | | | |
| (×10⁻⁷/° C.) | | | | | | | | | |
| Relative | 11.2 | 11.2 | 11.3 | 11.4 | 11.6 | 11.7 | 11.8 | 11.9 | 12.0 |
| Dielectric | | | | | | | | | |
| Constant | | | | | | | | | |
| Glass Stability | A | A | A | A | A | A | B | A | A |
| Overall | B | B | B | B | B | B | D | B | B |
| Evaluation | | | | | | | | | |
| a* | −1.9 | −2.0 | −2.0 | −2.0 | −2.1 | −2.1 | — | −2.1 | −2.1 |
| b* | 5.8 | 4.9 | 4.4 | 3.7 | 3.2 | 3.1 | — | 2.5 | 2.4 |

TABLE 12

| Glass | No. | | | | | | | | | |
|---|---|---|---|---|---|---|---|---|---|---|
| Composition/ | 111 | 112 | 113 | 114 | 115 | 116 | 117 | 118 | 119 | 120 |
| SiO2 | 15.10 | 14.90 | | 12.10 | 1.30 | 1.90 | 1.90 | 0.10 | 2.80 | 2.90 |
| B2O3 | 22.40 | 9.80 | 50.20 | 24.40 | 28.40 | 32.20 | 36.30 | 21.10 | 27.50 | 29.30 |
| ZnO | 27.30 | 32.80 | 27.10 | 14.00 | 50.20 | 26.00 | 33.30 | 26.00 | 30.40 | 32.40 |
| Al2O3 | 0.50 | 2.50 | 0.10 | 5.30 | 2.20 | 10.20 | 4.40 | 1.00 | 0.50 | 0.60 |
| Bi2O3 | 29.30 | 29.20 | 8.30 | 18.30 | 6.60 | 19.70 | 1.70 | 40.90 | 27.50 | 29.70 |
| MgO | | | | | | | | | 6.00 | |
| CaO | | 4.20 | | | 4.30 | 2.10 | 4.20 | 6.50 | 5.00 | 4.80 |
| SrO | | 0.40 | | | 2.60 | 1.60 | 2.90 | | | |
| BaO | 5.10 | 5.90 | 14.00 | 21.20 | 4.10 | 6.00 | 15.00 | 4.10 | | |
| Li2O | | | | 1.20 | | | | | | |
| Na2O | | | | | | | | | | |
| K2O | | | | 1.90 | | | | | | |
| MoO3 | 0.30 | 0.30 | 0.30 | 0.60 | 0.30 | 0.30 | 0.30 | 0.30 | 0.30 | 0.30 |
| WO3 | | | | 1.00 | | | | | | |
| Glass Transition | 498 | — | 481 | 493 | — | 499 | 506 | — | — | 468 |
| Point(° C.) | | | | | | | | | | |
| Softening | 602 | — | 578 | 605 | — | 601 | 604 | — | — | 564 |
| Point(° C.) | | | | | | | | | | |
| Thermal | 60 | — | 59 | 73 | — | 62 | 65 | — | — | 59 |
| Expansion | | | | | | | | | | |
| Coefficient | | | | | | | | | | |
| (×10⁻⁷/° C.) | | | | | | | | | | |
| Relative | 10.8 | — | 8.6 | 11.0 | — | 10.1 | 7.9 | — | — | 10.8 |
| Dielectric | | | | | | | | | | |
| Constant | | | | | | | | | | |
| Glass Stability | B | D | B | C | D | B | B | D | D | B |
| Overall | C | D | C | D | D | C | C | D | D | C |
| Evaluation | | | | | | | | | | |

TABLE 13

| Glass | No. | | | | | | | | | | |
|---|---|---|---|---|---|---|---|---|---|---|---|
| Composition/ | 121 | 122 | 123 | 124 | 125 | 126 | 127 | 128 | 129 | 130 | 131 |
| SiO2 | 0.80 | 2.80 | 0.30 | 2.90 | 0.30 | 1.10 | 0.30 | 5.60 | 5.60 | 5.60 | 5.60 |
| B2O3 | 28.80 | 33.40 | 29.90 | 34.30 | 25.90 | 34.40 | 27.10 | 17.00 | 17.00 | 17.00 | 17.00 |
| ZnO | 26.50 | 29.00 | 26.20 | 28.50 | 32.00 | 27.80 | 30.10 | 31.20 | 31.20 | 31.20 | 31.20 |
| Al2O3 | 1.30 | 0.80 | 1.10 | 1.10 | 0.90 | 1.60 | 0.70 | 0.90 | 0.90 | 0.90 | 0.90 |
| Bi2O3 | 3.80 | 29.00 | 4.00 | 28.10 | 2.20 | 30.00 | 3.20 | 25.50 | 25.50 | 25.50 | 25.50 |
| MgO | | | | | | | | | | | |
| CaO | 38.50 | | | | | 1.80 | 15.00 | 8.00 | 8.00 | 8.00 | 8.00 |
| SrO | | 4.70 | 38.20 | | | 1.00 | 9.80 | | | | |
| BaO | | | | 4.80 | 38.40 | 2.00 | 13.50 | | | | |
| Li2O | | | | | | | | 11.00 | | | 3.00 |
| Na2O | | | | | | | | | 11.00 | | 3.00 |
| K2O | | | | | | | | | | 11.00 | 5.00 |
| MoO3 | 0.30 | 0.30 | 0.30 | 0.30 | 0.30 | 0.30 | 0.30 | 0.80 | 0.80 | 0.80 | 0.80 |
| WO3 | | | | | | | | | | | |
| Glass Transition | — | 462 | — | 458 | 496 | 462 | — | 473 | 473 | 472 | 473 |
| Point(° C.) | | | | | | | | | | | |
| Softening | — | 561 | — | 560 | 601 | 558 | — | 571 | 569 | 570 | 569 |
| Point(° C.) | | | | | | | | | | | |
| Thermal | — | 58 | — | 58 | 81 | 59 | — | 86 | 86 | 87 | 87 |
| Expansion | | | | | | | | | | | |
| Coefficient | | | | | | | | | | | |
| (×10⁻⁷/° C.) | | | | | | | | | | | |
| Relative | — | 10.6 | — | 10.7 | 10.3 | 10.7 | — | 10.0 | 10.1 | 10.0 | 10.0 |
| Dielectric | | | | | | | | | | | |
| Constant | | | | | | | | | | | |
| Glass Stability | D | B | D | B | C | B | D | B | B | B | B |
| Overall | D | C | D | C | D | C | D | C | C | C | C |
| Evaluation | | | | | | | | | | | |

The percentages of the compositions indicated in each table are weight percentages (wt %). Raw materials were mixed together so that the compositions indicated in Tables 1 to 13 were obtained. The raw materials thus mixed together were melted in an electric furnace with a temperature of 1100 to 1200° C. for one hour using a platinum crucible. Thereafter, the molten glass thus obtained was cooled rapidly by being pressed with a brass plate, and thus glass cullet was produced.

### (Evaluation of Glass)

The softening point of each glass was measured with a macro differential thermal analyzer. Then the value of the second heat absorption peak was employed. The glass transition point and the thermal expansion coefficient were measured with a thermomechanical analyzer with respect to each rod having a size of 4 mm×4 mm×20 mm formed from the glass cullet that had been remelted. The relative dielectric constant was measured with a LCR meter at a frequency of 1 MHz with respect to each plate having a size of 20 mm×20 mm×3 mm in thickness. The plate was formed from the glass cutlet that had been remelted, and had electrodes that had been vapor-deposited on the surface thereof. The glass stability was evaluated through the measurement of variations with a differential thermal analyzer and the observation of the presence of crystals with an optical microscope.

Tables 1 to 13 show the evaluation results and overall evaluations. The definitions of “A”, “B”, “C” and “D” used to evaluate the glass stability are as follows:

A: the composition vitrified, no variations that accompany crystallization were observed by differential thermal analysis, and no crystals were observed with the optical microscope;

B: the composition vitrified, and variations that accompany crystallization were observed by the differential thermal analysis but no crystals were observed with the optical microscope;

C: the composition vitrified, but variations in enthalpy were observed in the range of temperatures higher than the softening point, and no diffraction peaks attributable to crystals were observed by the X-ray diffraction method but crystals were observed with the optical microscope; and

D: the composition did not vitrify during the glass production.

In Tables 1 to 13, the overall evaluation was made comprehensively with target criteria of a softening point of lower than 600° C., more preferably lower than 595° C., a relative dielectric constant of 12 or less, more preferably 11 or less, and a thermal expansion coefficient in the range of 60×10⁻⁷ to 85×10⁻⁷/C.°, more preferably in the range of 65×10⁻⁷ to 85×10⁻⁷/C.°, and further in consideration of stability of the glass.

The definitions of “A”, “B”, “C” and “D” used for the overall evaluation are as follows:

A: the composition allowed glass to be stable, respective values indicating physical properties were within the ranges of the more preferable target values, and the respective physical properties were in balance;

B: the composition allowed glass to be stable, and respective values indicating physical properties were within the ranges of the target values, but at least one of the values indicating the physical properties was outside the range of the more preferable target values;

C: the composition allowed glass to be stable, but at least one of the values indicating the physical properties was outside the range of the target values; and

D: the composition did not vitrify and therefore was not available as a glass material.

As is apparent from Tables 1 to 11, each of the glass samples having a composition that falls within the preferable ranges of values to be used for the PDP according to the present invention had a thermal expansion coefficient of 60 to 85×10⁻⁷/C.° in the temperature range of 30 to 300 C.°, a softening point of 600 C.° or lower, and a relative dielectric constant of 12 or lower, and allowed the glass to have good stability.

The glass samples shown in Tables 12 and 13 contain some components whose contents are outside the preferable ranges to be used for the PDP according to the present invention. Therefore, such glass samples had lower values than those of the samples shown in Tables 1 to 7 in some physical properties.

### <Production and Evaluation of PDP>

In order to examine the effect of decreasing the degree of yellowing provided through the addition of MoO₃ and WO₃ in the present invention, PDPs were produced using the glass samples having compositions as shown in Tables 1 to 11. Then, each PDP was evaluated. The results of the evaluation are shown below.

### (Production of Glass Powder)

Raw materials were prepared according to the compositions indicated in the tables and mixed together. The raw materials thus mixed were melted in an electric furnace with a temperature of 1100 to 1200° C. for one hour using a platinum crucible. Thereafter, glass cutlet was produced by a twin-roller method and then was crushed with a ball mill. Thus, the powder thereof was prepared.

The glass powders of Examples and Comparative Examples thus prepared each had an average particle diameter of 1.5 to 3.5 μm.

### (Preparation of Glass Paste)

Ethyl cellulose, which was used as resin, and alpha-terpineol, which was used as a solvent, were mixed together in a weight ratio of 5:30, which then was stirred. Thus, a solution containing an organic component was prepared. Subsequently, this solution and each of the glass powders of Examples and Comparative Examples indicated in the tables were mixed together in a weight ratio of 65:35, which then was mixed well and dispersed with three rollers. Thus, glass pastes were prepared.

### (Production of PDP)

A material of ITO (transparent electrodes) was applied in a predetermined pattern onto the surface of a front glass substrate made of flat soda lime glass with a thickness of approximately 2.8 mm, and then was dried. Subsequently, a silver paste, which was a mixture of silver powder and an organic vehicle, was applied in the form of a plurality of lines. Thereafter, the front glass substrate was heated and thereby the silver paste was baked. Thus, display electrodes were formed.

The above-mentioned glass paste was applied to the front panel on which the display electrodes had been formed, by the blade coater method. Thereafter, the above-mentioned front glass substrate was maintained at 90° C. for 30 minutes so that the glass paste was dried, which then was baked at a temperature of 570° C. for 10 minutes. Thus, a dielectric layer was formed.

Magnesium oxide (MgO) was deposited on the above-mentioned dielectric layer by the electron-beam vapor deposition method and then was baked. Thus, a protective layer was formed.

On the other hand, the back panel was produced by the following method. First, address electrodes containing silver as its main component were formed in stripes, by screen printing, on a back glass substrate made of soda lime glass. Subsequently, a dielectric layer was formed. Next, barrier ribs were formed between adjacent address electrodes on the dielectric layer. The barrier ribs were formed by repeating the screen printing and baking.

Next, phosphor pastes of red (R), green (G), and blue (B) were applied to the wall surfaces of the barrier ribs and the surface of the dielectric layer that was exposed between the barrier ribs, and then were dried and baked. Thus, phosphor layers were produced.

The front panel and the back panel thus produced were bonded to each other with sealing glass. Thereafter, the discharge spaces were evacuated to a high vacuum (approximately 1×10⁻⁴ Pa) and then were charged with Ne—Xe-based discharge gas so as to have a predetermined pressure. Thus, a PDP was produced.

### (Evaluation of PDP)

With respect to the display surface side of each panel thus produced, the degree of coloring was measured with a color difference meter. Tables 1 to 4, 7 and 8 show the results of the measurement with respect to the PDPs produced using, as dielectric layers, the glasses having the respective compositions indicated therein. In these tables, “a*” and “b*” are the values in the L*a*b* color system. A higher positive value of a* indicates a stronger red color, while a higher negative value of a* indicates a stronger green color. A higher positive value of b* indicates a stronger yellow color, while a higher negative value of b* indicates a stronger blue color. Generally, when an a* value is in the range of −5 to +5 and a b* value also is in the range of −5 to +5, no coloring of the front panels is observed. Since yellowing is particularly affected by the magnitude of the b* value, it is preferable that the PDPs each have a b* value in the range of −5 to +5.

As shown in Tables 1 to 7, with respect to the samples with physical properties suitable for the material to be used for the dielectric layer, it was proved that the yellowing problem did not occur.

As is clear from the results shown in Tables 8 to 11, in Samples 71 and 88 as well as Samples 72, 79, 89 and 96, the b* values exceeded 5 and yellowing was observed. In Samples 71 and 88, neither MoO₃ nor WO₃ was contained, and in Samples 72, 79, 89 and 96, either one of MoO₃ and WO₃ was contained but the content thereof was 0.05 wt %. Furthermore, in Samples 78, 85, 95 and 102 in which either one of MoO₃ and WO₃ was contained but the content thereof was 5 wt %, the glass became clouded, and therefore the degree of coloring thereof could not be measured. On the other hand, in other samples in which either one of MoO₃ and WO₃ was contained and the content thereof was 0.1 wt % to 4 wt %, the b* values were all 5 or smaller, and thus it was proved that yellowing was prevented from occurring. Moreover, in Samples 86, 87, 103 and 104 containing both MoO₃ and WO₃, the b* values were smaller than those of other samples, and thus it was proved that they had a higher effect of preventing yellowing from occurring as compared to the cases where only one of them was contained.

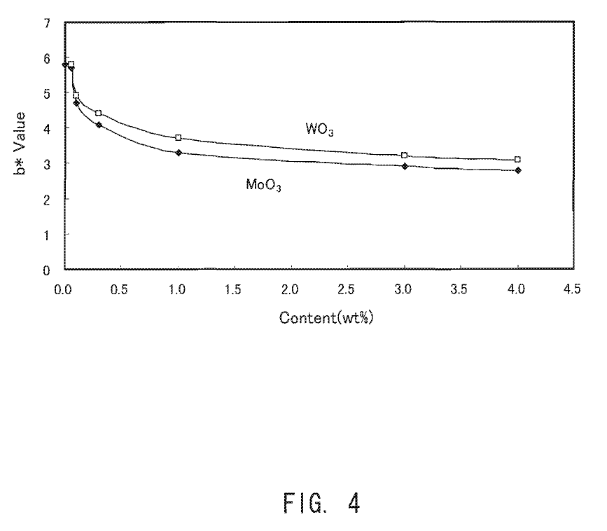

FIG. 4 shows the relationship between the content of MoO₃ or WO₃ and the measurement results of the b* values. As can be seen from the results, the b* value decreases with an increase in content of MoO₃ or WO₃ and becomes +5 or smaller, with the content of MoO₃ or WO₃ being at least 0.1 wt %. Thus it was proved that the yellowing problem was alleviated.

Furthermore, with respect to the panels in which the content of MoO₃ or WO₃ was at least 0.1 wt % and the b* values were lower, the dielectric breakdown of the dielectrics did not occur even when the PDPs were operated.

The examples of the PDP described above each are an example whose dielectric layer is formed of one layer. However, the same evaluation results were obtained even when the dielectric layer has a two-layer structure including a first dielectric layer, which is the above-mentioned dielectric layer, and a second dielectric layer formed thereon. Examples of the compositions of glasses to be used for the second dielectric layer in this case are indicated in Table 14.

TABLE 14

| Glass | | |
|---|---|---|
| Composition | First Example | Second Example |
| SiO2 | 11.1 | 11.8 |
| B2O3 | 22.8 | 36.4 |
| ZnO | 17.5 | 37.2 |
| Al2O3 | 4.5 | 1.6 |
| Bi2O3 | 25.0 | |
| BaO | 16.8 | |
| Li2O | 2.3 | |
| K2O | | 13.0 |

### INDUSTRIAL APPLICABILITY

A plasma display panel of the present invention is suitably applicable to a plasma display panel in which a dielectric layer that is used to cover display electrodes and address electrodes is formed of glass that is free from lead. This makes it possible to obtain a highly reliable plasma display panel in which yellowing and dielectric breakdown are prevented from occurring.

1. A plasma display panel comprising a display electrode and an address electrode that cross each other, at least one selected from the display electrode and the address electrode being covered with a first dielectric layer containing first glass,
wherein the first glass contains Bi₂O₃, and the electrode that is covered with the first dielectric layer contains at least one selected from the group consisting of silver and copper, and
wherein the first glass further contains 0 to 4 wt % of MoO₃ and 0 to 4 wt % of WO₃, and the total of the contents of MoO₃ and WO₃ in the first glass is in a range of 0.1 to 8 wt %.

2. The plasma display panel according to claim 1, wherein the content of Bi₂O₃ in the first glass is 2 to 40 wt %.

3. The plasma display panel according to claim 2, wherein the first glass contains, as components thereof:
0 to 15 wt % SiO₂;
10 to 50 wt % B₂O₃;
15 to 50 wt % ZnO;
0 to 10 wt % Al₂O₃;
2 to 40 wt % Bi₂O₃;
0 to 5 wt % MgO;
5 to 38 wt % CaO+SrO+BaO;
more than 0.1 wt % but not more than 10 wt % Li₂O+Na₂O+K₂O;
0 to 4 wt % MoO₃; and
to 4 wt % WO₃, and
the total of the contents of MoO₃ and WO₃ in the first glass is in a range of 0.1 to 8 wt %.

4. The plasma display panel according to claim 2, wherein the first glass contains, as components thereof:
more than 2 wt % but not more than 15 wt % SiO₂;
10 to 50 wt % B₂O₃;
15 to 50 wt % ZnO;
0 to 10 wt % Al₂O₃;
2 to 40 wt % Bi₂O₃;
0 to 5 wt % MgO;
5 to 38 wt % CaO+SrO+BaO;
0.1 to 10 wt % Li₂O+Na₂O+K₂O;
0 to 4 wt % MoO₃; and
0 to 4 wt % WO₃, and
the total of the contents of MoO₃ and WO₃ in the first glass is in a range of 0.1 to 8 wt %.

5. The plasma display panel according to claim 2, wherein the first glass contains, as components thereof:
more than 2 wt % but not more than 15 wt % SiO₂;
10 to 50 wt % B₂O₃;
15 to 50 wt % ZnO;
0 to 10 wt % Al₂O₃;
2 to 40 wt % Bi₂O₃;
0 to 5 wt % MgO;
5 to 38 wt % CaO+SrO+BaO;
more than 0.1 wt % but not more than 10 wt % Li₂O+Na₂O+K₂O;
0 to 4 wt % MoO₃; and
0 to 4 wt % WO₃, and
the total of the contents of MoO₃ and WO₃ in the first glass is in a range of 0.1 to 8 wt %.

6. The plasma display panel according to claim 3, wherein the contents of Li₂O, Na₂O, and K₂O in the first glass are 0.17 wt % or less, 0.36 wt % or less, and 0.55 wt % or less, respectively, and the total of the contents of Li₂O, Na₂O, and K₂O is 0.55 wt % or less.

7. The plasma display panel according to claim 1, wherein the content of lead in the first glass is 0.1 wt % or less.

8. The plasma display panel according to claim 1, further comprising a second dielectric layer that is provided on the first dielectric layer.

9. The plasma display panel according to claim 8, wherein the second dielectric layer contains second glass, and
the second glass contains, as components thereof, at least one selected from the group consisting of Li₂O, Na₂O, and K₂O.

10. The plasma display panel according to claim 9, wherein the second glass contains, as components thereof:
0 to 15 wt % SiO₂;
10 to 50 wt % B₂O₃;
15 to 50 wt % ZnO;
0 to 10 wt % Al₂O₃;
2 to 40 wt % Bi₂O₃;
0.1 to 10 wt % Li₂O+Na₂O+K₂O;
0 to 5 wt % MgO; and
5 to 38 wt % CaO+SrO+BaO.

11. The plasma display panel according to claim 9, wherein the second glass contains, as components thereof:
0 to 30 Wt % SiO₂;
25 to 80 wt % B₂O₃;
0 to 50 wt % ZnO;
0 to 10 wt % Al₂O₃;
5 to 20 wt % Li₂O+Na₂O+K₂O;
0 to 5 wt % MgO; and
0 to 15 wt % CaO+SrO+BaO.

12. The plasma display panel according to claim 1, wherein the electrode to be covered with the first dielectric layer is formed on a glass substrate, and the glass substrate contains Sn.

13. A method of producing a plasma display panel, the method comprising forming a first dielectric layer that covers an electrode by placing a first glass material containing first glass on a substrate on which the electrode has been formed and baking the first glass material,
wherein the first glass contains Bi₂O₃, and the electrode that is covered with the first dielectric layer contains at least one selected from the group consisting of silver and copper, and
wherein the first glass further contains 0 to 4 wt % of MoO₃ and 0 to 4 wt % of WO₃, and the total of the contents of MoO₃ and WO₃ in the first glass is in a range of 0.1 to 8 wt %.

14. The method of producing a plasma display panel according to claim 13, wherein the content of Bi₂O₃ in the first glass is 2 to 40 wt %.

15. The method of producing a plasma display panel according to claim 14, wherein the first glass contains, as components thereof:
0 to 15 wt % SiO₂;
10 to 50 wt % B₂O₃;
15 to 50 wt % ZnO;
0 to 10 wt % Al₂O₃;
2 to 40 wt % Bi₂O₃;
0 to 5 wt % MgO;
to 38 wt % CaO+SrO+BaO;
more than 0.1 wt % but not more than 10 wt % Li₂O+Na₂O+K₂O;
0 to 4 wt % MoO₃; and
to 4 wt % WO₃, and
the total of the contents of MoO₃ and WO₃ in the first glass is in a range of 0.1 to 8 wt %.

16. The method of producing a plasma display panel according to claim 14, wherein the first glass contains, as components thereof:
more than 2 wt % but not more than 15 wt % SiO₂;
10 to 50 wt % B₂O₃;
15 to 50 wt % ZnO;
0 to 10 wt % Al₂O₃;
2 to 40 wt % Bi₂O₃;
0 to 5 wt % MgO;
5 to 38 wt % CaO+SrO+BaO;
0.1 to 10 wt % Li₂O+Na₂O+K₂O;
0 to 4 wt % MoO₃; and
0 to 4 wt % WO₃, and
the total of the contents of MoO₃ and WO₃ in the first glass is in a range of 0.1 to 8 wt %.

17. The method of producing a plasma display panel according to claim 14, wherein the first glass contains, as components thereof:
more than 2 wt % but not more than 15 wt % SiO₂;
10 to 50 wt % B₂O₃;
15 to 50 wt % ZnO;
0 to 10 wt % Al₂O₃;
2 to 40 wt % Bi₂O₃;
0 to 5 wt % MgO;
5 to 38 wt % CaO+SrO+BaO;
more than 0.1 wt % but not more than 10 wt % Li₂O+Na₂O+K₂O;
0 to 4 wt % MoO₃; and
0 to 4 wt % WO₃, and
the total of the contents of MoO₃ and WO₃ in the first glass is in a range of 0.1 to 8 wt %.

18. The method of producing a plasma display panel according to claim 15, wherein the contents of Li₂O, Na₂O, and K₂O in the first glass are 0.17 wt % or less, 0.36 wt % or less, and 0.55 wt % or less, respectively, and the total of the contents of Li₂O, Na₂O, and K₂O is 0.55 wt % or less.

19. The method of producing a plasma display panel according to claim 13, wherein the content of lead in the first glass is 0.1 wt % or less.

20. The method of producing a plasma display panel according to claim 13, further comprising forming a second dielectric layer by placing a second glass material containing second glass on the first dielectric layer and baking the second glass material.

21. The method of producing a plasma display panel according to claim 20, wherein the second glass contains, as components thereof, at least one selected from the group consisting of Li₂O, Na₂O, and K₂O.

22. The method of producing a plasma display panel according to claim 21, wherein the second glass contains, as components thereof:
0 to 15 wt % SiO₂;
10 to 50 wt % B₂O₃;
15 to 50 wt % ZnO;
0 to 10 wt % Al₂O₃;
2 to 40 wt % Bi₂O₃;
0.1 to 10 wt % Li₂O+Na₂O+K₂O;
0 to 5 wt % MgO; and
5 to 38 wt % CaO+SrO+BaO.

23. The method of producing a plasma display panel according to claim 21, wherein the second glass contains, as components thereof:
0 to 30 wt % SiO₂;
25 to 80 wt % B₂O₃;
0 to 50 wt % ZnO;
0 to 10 wt % Al₂O₃;
5 to 20 wt % Li₂O+Na₂O+K₂O;
0 to 5 wt % MgO; and
0 to 15 wt % CaO+SrO+BaO.

24. The method of producing a plasma display panel according to claim 13, wherein the substrate is a glass substrate, and the glass substrate contains Sn.
